SEQUENCE LISTING (3 sequences)

SEQ ID NO: 1 - DNA, 106 bp, synthetic construct
  source 1..106: mol_type = other DNA
atgtctttgcagccgaggaggagctggtggaggctgacgaggcgggcagtgtgtatgcaggcatcctcagctacggggtgggcttcttcctgttcatcctggtggt

SEQ ID NO: 2 - DNA, 25 bp, synthetic construct
  source 1..25: mol_type = other DNA
agctcctcctcggctgcaaagacat

SEQ ID NO: 3 - DNA, 25 bp, synthetic construct
  source 1..25: mol_type = other DNA
accaccaggatgaacaggaagaagc

(19) United States
(12) Patent Application Publication
(10) Pub. No.: US 2024/0145134 A1
(43) Pub. Date: May 2, 2024

(54) POLYMER PARTICLE CONTAINING MAGNETIC MATERIAL, MEDIUM FOR SENSORS, AND SENSOR DEVICE

(71) Applicant: TDK CORPORATION, Tokyo (JP)

(72) Inventors: Toshiki GUSHI, Tokyo (JP); Kazuhiro YOSHIDOME, Tokyo (JP); Akito HASEGAWA, Tokyo (JP); Isao KANADA, Tokyo (JP)

(73) Assignee: TDK CORPORATION, Tokyo (JP)

(21) Appl. No.: 18/175,139

(22) Filed: Feb. 27, 2023

(30) Foreign Application Priority Data
Feb. 28, 2022 (JP) 2022-030076

(51) Int. Cl. H01F 1/00; G01N 27/72

(52) U.S. Cl. CPC H01F 1/0054; G01N 27/72

(57) ABSTRACT

A polymer particle containing magnetic material includes a core and a polymer layer. The core includes magnetic fine particles. The polymer layer is located outside the core and surrounds the core. A shape ratio (Ric) is defined in each of the magnetic fine particles by dividing a diameter (Di) of an inscribed circle of the magnetic fine particle by a diameter (Do) of a circumscribed circle of the magnetic fine particle. The shape ratio (Ric) of the magnetic fine particle is 0.50 or more and 0.94 or less. The diameter (Di) of the magnetic fine particle is 5 nm or more. The diameter (Di) and the shape ratio (Ric) of the magnetic fine particle satisfy a relation formula of Di≤9.28×e\hat{ }(1.17×Ric).

The present application contains a Sequence Listing that has been submitted electronically and is hereby incorporated by reference herein in its entirety. The electronic Sequence Listing is named 223767 Sequence Listing.xml, which was created on Feb. 27, 2023 and is 3,609 bytes in size.

### BACKGROUND OF THE INVENTION

The present invention relates to a polymer particle containing magnetic material capable of being used, for example, in magnetic biosensors, a medium for sensors including the particle, and a sensor device using the polymer particle containing magnetic material.

In the fields of biochemistry, medicine, and the like, a magnetic biosensor is known as a technique for detecting proteins, nucleic acids, cells, and the like in specimens. The magnetic biosensor is a method for detecting the existence and concentration of target substances in specimens by detecting the existence and number of magnetic particles located near the surface of the detection unit. The magnetic biosensor can detect the target substances with high sensitivity and has an advantage of avoiding the use of unstable compounds as conventional detection methods using optical systems.

Patent Document 1 below proposes a method for producing magnetic particles. In Patent Document 1, non-magnetic particles having a particle size equal to or less than half a particle size of magnetic mother particles are provided on the surfaces of magnetic mother particles, and they are coated with a polymer. Patent Document 2 proposes a polymer-coated ferromagnetic particle. In Patent Document 2, ferrite particles are coated with a polymer layer and a polyglycidyl methacrylate (pGMA) layer, and the weight ratio of ferromagnetic particles is more than 33% and less than 88%.

The magnetic particles used for such magnetic biosensors are required to have a high saturation magnetization, a difficulty in settling in a detection unit, and a high dispersion stability. If the magnetic particles settle in the detection unit, they become a noise component during signal detection, resulting in a decrease in detection sensitivity.
Patent Document 1: JP5003867 (B2)
Patent Document 2: JP2018133467 (A)

### BRIEF SUMMARY OF THE INVENTION

The present invention has been achieved under such circumstances. It is an object of the invention to provide a polymer particle containing magnetic material capable of reducing noise and improving detection sensitivity, a medium for sensors containing the polymer particle, and a sensor device using the polymer particle containing magnetic material.

To achieve the above object, a polymer particle containing magnetic material according to the present invention comprises:
a core including magnetic fine particles; and
a polymer layer located outside the core and surrounding the core,

wherein
a shape ratio (Ric) is defined in each of the magnetic fine particles by dividing a diameter (Di) of an inscribed circle of the magnetic fine particle by a diameter (Do) of a circumscribed circle of the magnetic fine particle,
the shape ratio (Ric) of the magnetic fine particle is 0.50 or more and 0.94 or less,
the diameter (Di) of the magnetic fine particle is 5 nm or more, and
the diameter (Di) and the shape ratio (Ric) of the magnetic fine particle satisfy a relation formula of Di≤9.28×e\hat{ }(1.17×Ric).

The present inventors have newly found that the polymer particle containing magnetic material of the present invention can achieve high sensor sensitivity and background signal (noise) reduction at the same time. This is probably because the magnetic fine particles in the polymer particle containing magnetic material each having a shape ratio within a predetermined range can exhibit sufficient magnetic properties for detection and prevent sedimentation of the polymer particles.

In the polymer particle containing magnetic material of the present invention, since the polymer layer is located around the core, the dispersibility of the particles is enhanced by reduction in aggregation among the particles, and sedimentation of the polymer particle can be prevented. Moreover, it is conceivable that high magnetization and low coercivity (superparamagnetism) can be achieved by the diameter of the inscribed circle of the magnetic fine particles within a predetermined range. Note that, if the diameter of the inscribed circle of the magnetic fine particles is too small, the surface area of the particles increases, which tends to reduce the magnetization and the detection signal intensity. Moreover, if the above-mentioned relation formula is not satisfied, aggregation and sedimentation tend to easily occur due to ferromagnetism.

Moreover, when the shape ratio is within the above-mentioned range, the magnetization is improved by the crystallinity of the magnetite, and the packing property is obtained by the shape effect of the magnetic fine particles. If the shape ratio is too high, the packing property is improved excessively, and the magnetic fine particles tend to be ferromagnetized. If the shape ratio is too low, the magnetic fine particles are no longer isotropic, the packing property of the fine particles decreases, the magnetization tends to decrease, and the magnetic fine particles tend to be ferromagnetized due to the shape magnetic anisotropy of the fine particles.

Preferably, the polymer particle containing magnetic material comprises an intermediate layer located inside the polymer layer and outside the core and having a lower concentration of the magnetic fine particles than the core. Preferably, a thickness of the intermediate layer is 5% or more and 60% or less of a radius of the polymer particle containing magnetic material.

Preferably, a polymer particle containing magnetic material comprises an intermediate layer located inside the polymer layer and outside the core and having a lower concentration of the magnetic fine particles than the core. Preferably, a thickness of the intermediate layer is 5% or more and 60% or less of a radius of the polymer particle containing magnetic material. When the polymer particle containing magnetic material comprises the intermediate layer, the specific gravity of the polymer particle decreases, aggregation and sedimentation are further less likely to occur, and the sensor sensitivity is improved.

Preferably, a thickness of the intermediate layer is 5% or more and 60% or less of a radius of the polymer particle containing magnetic material. More preferably, a thickness of the intermediate layer is 10% or more and 42% or less of a radius of the polymer particle containing magnetic material. If the thickness of the intermediate layer is too small, the thickness of the polymer layer relatively becomes large, or the region of the core relatively becomes large. If the thickness of the polymer layer increases, the total amount of the magnetic fine particles contained in the polymer particle tends to decrease, and the detection sensitivity tends to decrease. If the region of the core relatively becomes large, the specific gravity of the polymer particle becomes large, and the polymer particle tends to settle easily.

Preferably, a ratio (x1/x2) of a diameter (x1) of the magnetic fine particles to a diameter (x2) of the polymer particle containing magnetic material is 0.25 or less. In this range, it is possible to easily achieve high sensor sensitivity and background signal (noise) reduction at the same time.

Preferably, a polymer constituting the polymer layer contains an unpolymerized vinyl group. Instead, preferably, the polymer particle containing magnetic material has a peak in 1620 to 1640 cm⁻¹ in a FT-IR spectrum. For example, when the polymer contains an unpolymerized vinyl group, the dispersion in an aqueous solution (aqueous medium) is improved, aggregation and sedimentation are less likely to occur, and it is possible to prevent an increase in background signal.

The polymer particle containing magnetic material may further comprise a portion capable of directly or indirectly binding with a target substance.

The polymer particle containing magnetic material may be contained in a medium for sensors used for magnetic biosensor devices or the like.

A sensor device may comprise a sensor unit for detecting a magnetism of the polymer particle containing magnetic material binding with a target substance.

In the fields of biochemistry, medicine, and the like, a magnetic biosensor is known as a technique for detecting proteins, nucleic acids, cells, and the like in specimens. The magnetic biosensor is a method for detecting the existence and concentration of target substances in specimens by detecting the existence and number of magnetic particles located near the surface of the detection unit. The magnetic biosensor can detect the target substances with high sensitivity and has an advantage of avoiding the use of unstable compounds as conventional detection methods using optical systems. The polymer particle containing magnetic material according to the present invention can favorably be used as a medium for sensors of the magnetic biosensor.

### BRIEF DESCRIPTION OF THE DRAWING(S)

FIG. 1A is a schematic view of a polymer particle containing magnetic material according to an embodiment of the present invention;

FIG. 1B is a TEM (HAADF) image of a polymer particle containing magnetic material according to an example of the present invention;

FIG. 2A is a TEM image of magnetic fine particles contained in a polymer particle containing magnetic material according to an example of the present invention;

FIG. 2B is a TEM image of magnetic fine particles contained in a polymer particle containing magnetic material according to a comparative example of the present invention;

FIG. 3A is a schematic view illustrating a relation between an inscribed circle and a circumscribed circle of a magnetic fine particle contained in the polymer particle containing magnetic material according to an example of the present invention;

FIG. 3B is a schematic view illustrating a relation between an inscribed circle and a circumscribed circle of a magnetic fine particle contained in the polymer particle containing magnetic material according to a comparative example of the present invention;

FIG. 4 is a graph illustrating a difference between examples and comparative examples of the present invention;

FIG. 5 is a graph illustrating a concentration distribution (intensity distribution) of magnetic fine particles of a polymer particle containing magnetic material according to examples and comparative examples of the present invention;

FIG. 6 is a graph illustrating a FT-IR analysis result of magnetic fine particles of a polymer particle containing magnetic material according to examples and comparative examples of the present invention;

FIG. 7 is a schematic diagram of a sensor device according to an embodiment of the present invention;

FIG. 8A is a schematic view illustrating an application of a polymer particle containing magnetic material according to an embodiment of the present invention;

FIG. 8B is a schematic view illustrating the next step of FIG. 8A;

FIG. 8C is a schematic view illustrating the next step of FIG. 8B;

FIG. 8D is a schematic view illustrating the next step of FIG. 8C;

FIG. 8E is a schematic view illustrating the next step of FIG. 8D;

FIG. 9A is a graph illustrating an example of output of a sensor device using a polymer particle containing magnetic material according to an example of the present invention; and

FIG. 9B is a graph illustrating an example of output of a sensor device using a polymer particle containing magnetic material according to a comparative example of the present invention.

### DETAILED DESCRIPTION OF THE INVENTION

Hereinafter, the present invention is described based on an embodiment shown in the figures.

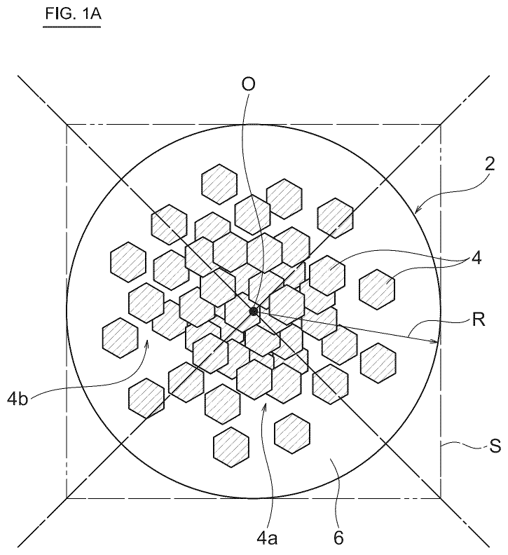

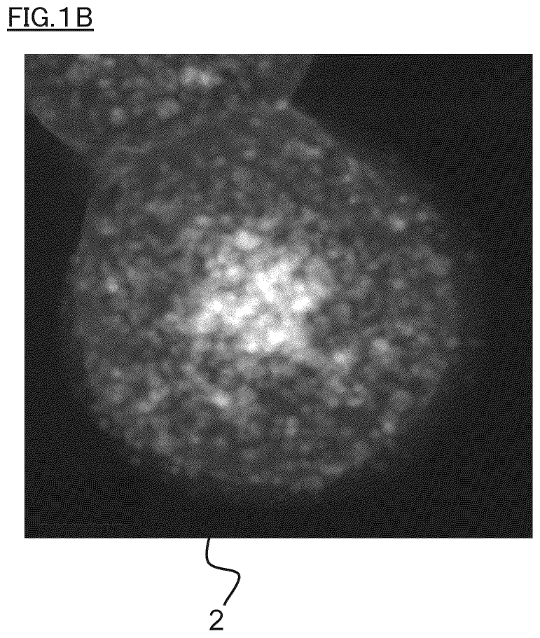

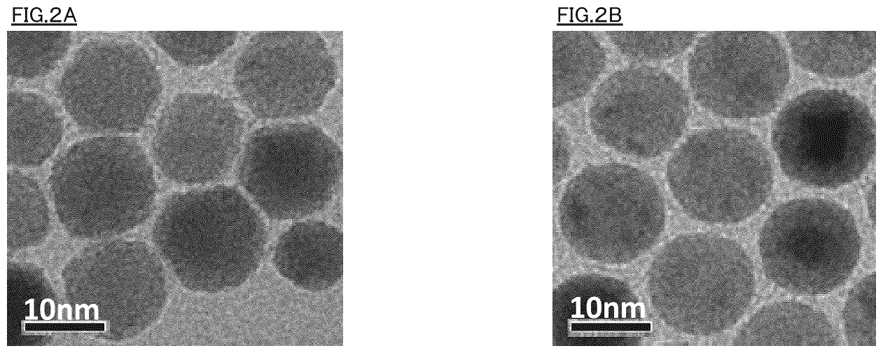

As shown in FIG. 1A, a polymer particle containing magnetic material (hereinafter, also referred to as a magnetic bead) 2 according to an embodiment of the present invention includes a core 4a containing magnetic fine particles 4 at a comparatively high concentration, an intermediate layer 4b containing the magnetic fine particles 4 at a lower concentration compared to the core 4a, and a polymer layer 6 covering the surface of the intermediate layer 4b.

The magnetic fine particles 4 are not limited as long as they are fine particles exhibiting ferromagnetism or superparamagnetism, but the magnetic fine particles 4 are preferably fine particles exhibiting superparamagnetism. For example, the magnetic material constituting the magnetic fine particles 4 is an iron oxide based compound, an iron nitride based compound, or the like, in addition to a single metal (e.g., Fe, Ni, and Co) and an alloy (e.g., a Fe—Ni alloy and a Fe—Co alloy). From the point of sufficient saturation magnetization and chemical stability, however, the magnetic material constituting the magnetic fine particles 4 is preferably an iron oxide based compound.

The iron oxide includes a ferrite represented by MFe₂O₄ (M=Co, Ni, Mg, Cu, Li_{0.5}Fe_{0.5}, etc.), a magnetite represented by Fe₃O₄, or γ-Fe₂O₃, but preferably includes either one of γ-Fe₂O₃ and Fe₃O₄ because of high saturation magnetization.

For example, the magnetic fine particles 4 have an average particle size of 5 to 31 nm for 30 or more magnetic fine particles 4 (random extraction) contained in a single magnetic bead 2. The standard deviation σ indicating the dispersion of the particle sizes is preferably within 20% of the average particle size and is more preferably 15% or less of the average particle size.

The particle size of the magnetic fine particle 4 is obtained by determining an area of the magnetic fine particle 4 within an observation range by image processing and being converted into a diameter of a perfect circle (circle equivalent diameter) corresponding to the area.

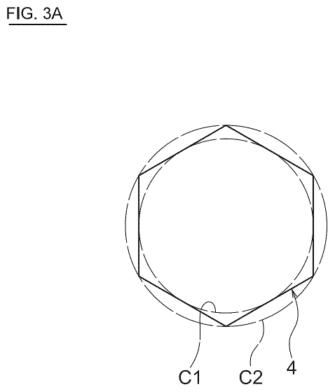

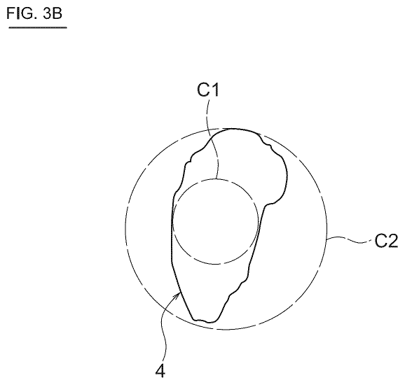

Moreover, for example, 10 or more magnetic beads 2 are selected at random, and 20 or more magnetic fine particles 4 contained in each of the magnetic beads 2 are extracted at random. Then, a shape ratio Ric shown below is defined for each of the magnetic fine particles 4. That is, as shown in FIG. 3A and FIG. 3B, a shape ratio Ric is defined by dividing a diameter Di of an inscribed circle C1 of the magnetic fine particle 4 by a diameter Do of a circumscribed circle C2 of this magnetic fine particle 4, and its average is calculated.

In the present embodiment, the shape ratio Ric (average) of the magnetic fine particles 4 is 0.50 or more and 0.94 or less and is preferably 0.6 to 0.93. Moreover, the standard deviation σ indicating the dispersion in the shape ratio Ric of the magnetic fine particles 4 is preferably within 0.15.

An average of the diameter Di of the inscribed circle C1 of each of the magnetic fine particles 4 (30 or more magnetic fine particles 4 extracted at random) is 5 nm or more and is preferably 10 to 30 nm. The standard deviation σ indicating the dispersion of the inner diameter Di (average) of the magnetic fine particles 4 is preferably within 25% of Di.

Moreover, a relation formula of Di≤9.28×e\hat{ }(1.17×Ric) is satisfied, where Di is a diameter (average/hereinafter not mentioned) of the inscribed circle C1 of the magnetic fine particles 4, and Ric is a shape ratio (average/hereinafter not mentioned). Note that, e\hat{ }(1.17×Ric) means e raised to the power of (1.17×Ric).

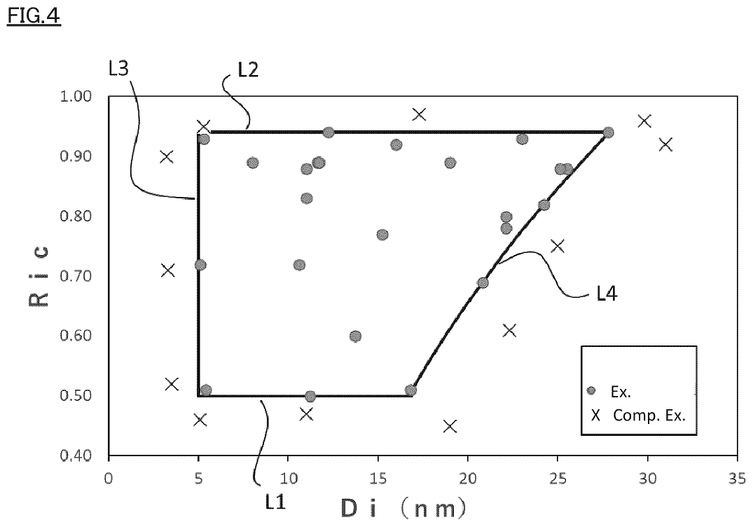

That is, in the present embodiment, the relation between the Ric and the diameter Di of the inscribed circle C1 of the magnetic particles 4 contained in the magnetic beads 2 is within the range of the region surrounded by the straight lines L1 to L3 and the curve L4 in the graph shown in FIG. 4. The horizontal axis of the graph shown in FIG. 4 is a diameter of the inscribed circle C1 of the magnetic particles 4, and the vertical axis shown in FIG. 4 is a shape ratio Ric of the magnetic particles 4. The straight line L1 is a straight line satisfying Ric=0.50, the straight line L2 is a straight line satisfying Ric=0.94, the straight line L3 is a straight line satisfying Di=5 nm, and the curve L4 is a curve satisfying a relation formula of Di=9.28×e\hat{ }(1.17×Ric).

Next, as shown in FIG. 1A, the intermediate layer 4b is described. In the present embodiment, the intermediate layer 4b shown in FIG. 1A is defined as a region surrounding the core 4a and containing the magnetic fine particles 4 within a concentration range of 10% to 50%, compared to a highest concentration of the magnetic fine particles 4 inside the magnetic bead 2. The concentration of the magnetic fine particles 4 inside the magnetic bead 2 is determined, for example, as follows.

For example, as shown in FIG. 1B, a TEM (HAADF) image of the magnetic bead 2 is prepared.

From the photographed image shown in FIG. 1B, as shown in FIG. 1A, a virtual quadrangle S circumscribing the outer contour of the magnetic bead 2 is determined, and an intersection point of the diagonal lines of the virtual quadrangle S is determined as a center O of the magnetic bead 2. Next, 12 virtual straight lines (not illustrated) are drawn every 30 degrees so as to divide the particle into 12 pieces from the center of the magnetic bead 2.

Next, a distance from the outer contour to the center O of the magnetic bead 2 is normalized from 0 to 100% along each of the virtual straight lines, and for example, a brightness intensity (corresponding to a concentration of the magnetic fine particles) of the image at each distance along each virtual straight line is obtained so as to calculate an average of the detected brightness intensities for the 12 virtual straight lines. The relation between the distance from the outer contour (outer surface) of the magnetic bead 2 and the detected brightness intensity (the concentration of the magnetic fine particles) obtained in such a manner can be obtained by average for a plurality (e.g., 10 or more) of magnetic beads 2 within an observation range. The detection intensity for brightness is normalized by setting the maximum value to 100 and the minimum value of the outer contour (polymer layer) to 0. FIG. 5 illustrates a graphed example of the relation between the distance from the outer surface of the magnetic bead 2 and the detection intensity for brightness (corresponding to the concentration of the magnetic fine particles) obtained in such a manner.

In FIG. 5, the horizontal axis indicates a distance (%) from the outer contour (outer surface) of the magnetic bead 2 to the center, and the vertical axis indicates a detection intensity (%/corresponding to a concentration of the magnetic fine particles). The distance of 100% corresponds to a radius R of the magnetic bead 2 (see FIG. 1A). In the present embodiment, as shown in FIG. 5, the intermediate layer 4b is defined as a region where the magnetic fine particles 4 exist within a concentration (detection intensity) of 10 to 50%, compared to a portion where the concentration (detection intensity) of the magnetic fine particles 4 is highest (100%) inside the magnetic bead 2.

In FIG. 5, for example, the graph of Ex. 1 or Ex. 21 is obtained in the magnetic bead 2 within the scope of the embodiment of the present invention. As shown in FIG. 5, the thickness of the intermediate layer 4b in the magnetic bead 2 within the scope of the embodiment of the present invention is about 16.8% and 41.8% as shown by the curves Ex. 1 and Ex. 21, respectively, which are within the scope (5 to 60%, preferably 10 to 42%) of the embodiment of the present invention.

A ratio (x1/x2) of a diameter (x1) of the magnetic fine particles 4 to a diameter (x2=2×R) of the magnetic bead 2 is preferably 0.005 to 0.25, more preferably 0.01 to 0.2, particularly preferably 0.01 to 0.15. The diameter of the magnetic bead 2 is obtained as a circle equivalent diameter, for example, by performing an image analysis of the outer contour of the magnetic bead 2 from the observed image shown in FIG. 1B.

In the polymer layer 6 of the magnetic bead 2 shown in FIG. 1A, preferably, a polymer constituting the polymer layer 6 contains an unpolymerized vinyl group. Preferably, a monomer for forming the polymer layer 6 includes 50% by weight or more of a hydrophobic monomer. Here, the hydrophobic monomer is a single substance or a mixture of a polymerizable monomer whose solubility in water at 25° C. is 2.5% by weight or less. The hydrophobic monomer may be any of a monofunctional (non-crosslinkable) monomer and a crosslinkable monomer and may be a mixture of a monofunctional monomer and a crosslinkable monomer.

As a monofunctional monomer of the hydrophobic monomer, it is possible to exemplify an aromatic vinyl monomer, such as styrene, α-methylstyrene, and halogenated styrene, an ethylenically unsaturated carboxylic acid alkyl ester, such as methyl acrylate, ethyl acrylate, ethyl methacrylate, stearyl acrylate, stearyl methacrylate, cyclohexyl acrylate, cyclohexyl methacrylate, isobornyl acrylate, and isobornyl methacrylate, and the like. As a crosslinkable monomer of the hydrophobic monomer, it is possible to exemplify a polyfunctional (meth)acrylate, such as ethylene glycol diacrylate, ethylene glycol dimethacrylate, trimethylolpropane triacrylate, trimethylolpropane trimethacrylate, pentaerythritol triacrylate, pentaerythritol trimethacrylate, dipentaerythritol hexaacrylate, and dipentaerythritol hexamethacrylate, a conjugated diolefin, such as butadiene and isoprene, divinylbenzene, diallyl phthalate, allyl acrylate, allyl methacrylate, and the like.

The monomer constituting the polymer layer 6 may include a non-hydrophobic monomer (hydrophilic monomer). As a monofunctional monomer of the non-hydrophobic monomer, it is possible to exemplify a monomer having a carboxyl group, such as acrylic acid, methacrylic acid, maleic acid, and itaconic acid, an acrylate having a hydrophilic functional group (e.g., hydroxyl group, amino group, alkoxy group), such as 2-hydroxyethyl acrylate, 2-hydroxyethyl methacrylate, glycerol acrylate, glycerol methacrylate, methoxyethyl acrylate, methoxyethyl methacrylate, polyethylene glycol acrylate, polyethylene glycol methacrylate, 2-dimethylaminoethyl(meth)acrylate, 2-diethylaminoethyl(meth)acrylate, 2-dimethylaminopropyl(meth)acrylate, and 3-dimethylaminopropyl(meth)acrylate, acrylamide, methacrylamide, N-methylol acrylamide, N-methylolmethacrylamide, diacetone acrylamide, N-(2-diethylaminoethyl)(meth)acrylamide, N-(2-dimethylaminopropyl)(meth)acrylamide, N-(3-dimethylaminopropyl)(meth)acrylamide, styrenesulfonic acid and its sodium salt, 2-acrylamido-2-methylpropanesulfonic acid and its sodium salt, isoprenesulfonic acid and its sodium salt, N,N-dimethylaminopropyl acrylamide and its methyl chloride quaternary salt, a copolymer with a copolymerizable monomer such as allylamine, and the like. As a cross-linkable monomer of the non-hydrophobic monomer. it is possible to exemplify a hydrophilic monomer, such as polyethylene glycol diacrylate, polyethylene glycol dimethacrylate, and poly(meth)acrylic ester of polyvinyl alcohol.

The polymer constituting the polymer layer 6 and the polymer dispersing the magnetic fine particles existing in the intermediate layer 4b are preferably the same continuous polymer, but they do not necessarily have to be the same polymer. Moreover, the polymer dispersing the magnetic fine particles 4 existing in the intermediate layer 4b and the polymer located among the magnetic fine particles 4 existing in the core 4a may be the same continuous polymer, but may be different polymers.

The polymer layer 6 may not contain the magnetic fine particles 4 at all, but may contain the magnetic fine particles 4. For example, the polymer layer 6 is defined as a region surrounding the intermediate layer 4b defined as described above and containing the magnetic fine particles 4 within a concentration of less than 10% (preferably 5% or less, and more preferably 3% or less including 0), compared to a portion where the concentration of the magnetic fine particles 4 is highest inside the magnetic bead 2.

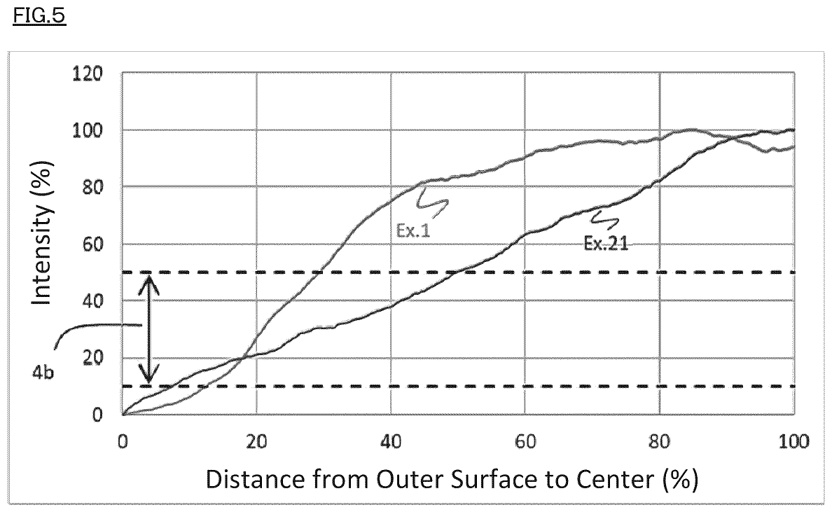

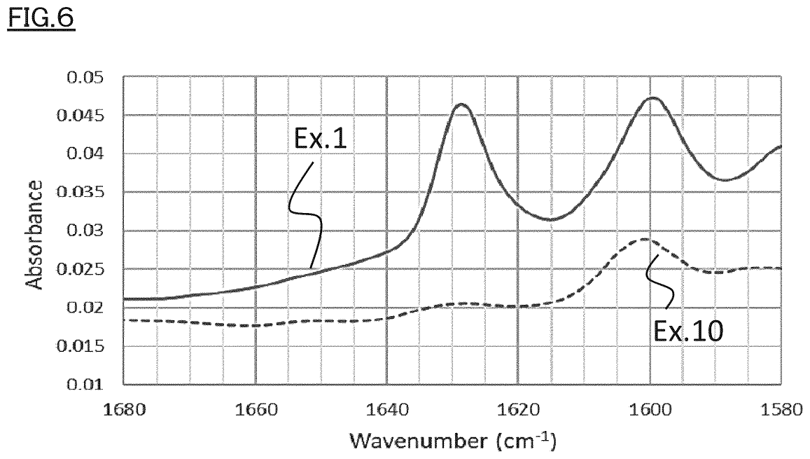

In the polymer layer 6 of the magnetic bead 2, as shown by the curve of Ex. 1 shown in FIG. 6, an intensity ratio of a peak in 1620 to 1640 cm⁻¹ to a peak in 1590 to 1610 cm⁻¹ in a FT-IR spectrum is 0.5 to 3.0. The peak appearing in 1590 to 1610 cm⁻¹ is a peak derived from an aromatic ring, and the peak in 1620 to 1640 cm⁻¹ is a peak derived from an unpolymerized vinyl group.

The polymer layer 6 of the magnetic bead 2 of the present embodiment may be added with a portion capable of directly or indirectly binding with a target substance to be detected. Instead, the outer surface of the polymer layer 6 may be provided with another polymer layer or a non-polymer layer added with a portion capable of directly or indirectly binding with a target substance to be detected.

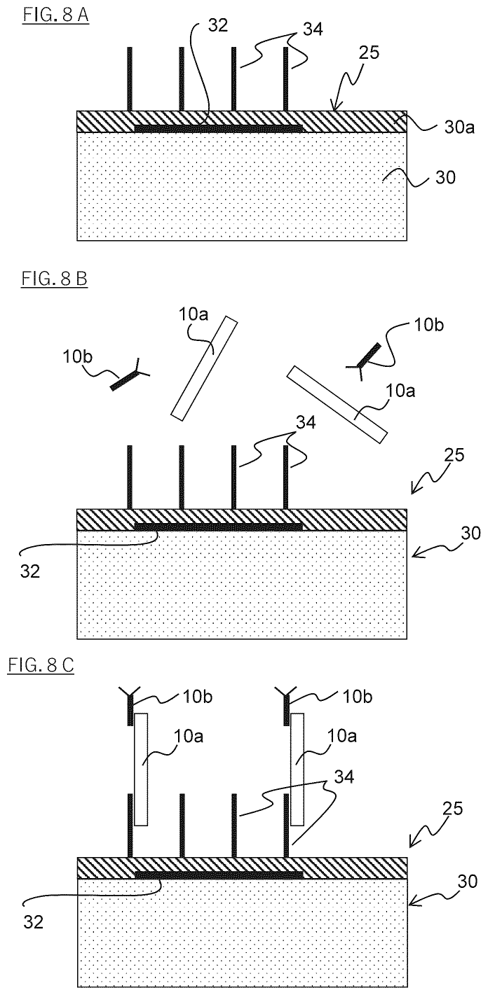

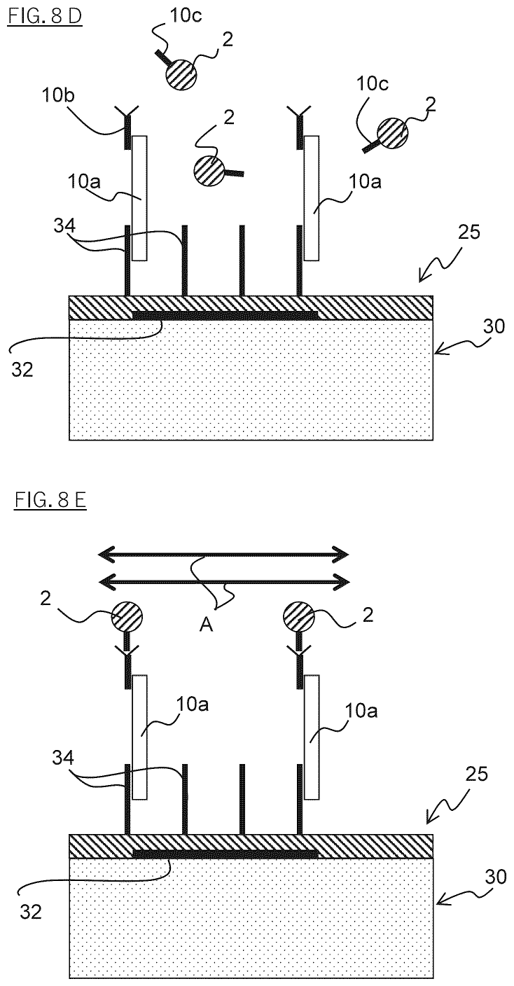

The target substance to be detected is not limited and is exemplified by, for example, a predetermined single-stranded nucleic acid 10a shown in FIG. 8D. The polymeric layer 6 of the magnetic bead 2 shown in FIG. 1A or another polymer layer or a non-polymer layer covering its surface may be capable of directly binding with the single-stranded nucleic acid 10a of the target substance shown in FIG. 8D or may be capable of binding with a binding auxiliary substance 10b or 10c being easy to bind with the single-stranded nucleic acid 10a of the target substance.

The magnetic bead 2 and the nucleic acid 10a as an example of the target substance are bound by any known method, such as coordinate bond, covalent bond, hydrogen bond, hydrophobic interaction, physical adsorption, and affinity bond, and may be bound indirectly via linkers or the like. As a specific binding method, for example, a functional group existing on the surface of the polymer layer 6 of the magnetic bead 2 and the nucleic acid 10a are bound by covalent bond. Moreover, there is a binding by interaction between the magnetic bead 2 added with the binding auxiliary substance 10c, such as avidin and streptavidin, and the nucleic acid having biotin or the binding auxiliary substance 10b.

Other examples of the binding auxiliary substance 10c as one linker include antibodies, antigens, protein A, and protein G. Other examples of the binding auxiliary substance 10b as the other linker include corresponding antigens or antibodies.

Next, a method for manufacturing the magnetic bead 2 according to present embodiment shown in FIG. 1A is described.

First, magnetic fine particles 4 are manufactured. The method for manufacturing the magnetic fine particles 4 is not limited and is, for example, coprecipitation method, thermal decomposition method, polyol method, sol-gel method, laser ablation method, thermal plasma method, and spray thermal decomposition method.

Each of the magnetic fine particles 4 contained in the magnetic beads 2 according to the present embodiment does not have a circular cross section, but has a polygonal cross section, such as a hexagonal cross section, as shown in FIG. 3A. The relation between the inscribed circle C1 and the shape ratio Ric is within the range of the region surrounded by the straight lines L1 to L3 and the curve L4 shown in FIG. 4. In order to produce such magnetic fine particles 4, in the present embodiment, the relation between the inscribed circle C1 and the shape ratio Ric of the magnetic fine particles 4 is controlled within a predetermined range by appropriately adjusting various conditions, such as raw material concentration, stirring speed, thermal decomposition temperature, time, heating rate, and method for recovery of synthesized nanoparticles, for example, using a method where iron oleate as a raw material is thermally decomposed in an oleylamine solvent.

For example, the average particle size and Di are increased by lowering the raw material concentration in the reaction solution at the beginning of the thermal decomposition reaction for the purpose of reduction in the amount of nucleation, performing the thermal decomposition reaction at a high temperature for the purpose of promotion of grain growth, or the like. Moreover, the iron oxide fine particles are polygonized, and Ric is lowered, by slowly increasing the temperature to the thermal decomposition reaction temperature for the purpose of enhancement in crystallinity of nanoparticles, maintaining the temperature at the thermal decomposition reaction temperature for a long time, or the like. Ric is further lowered by lowering the dispersion and binding the particles together by lowering the stirring speed of the reaction solution, adding a small amount of aggregating agent, or the like. On the other hand, Ric is heightened by using octadecene, which tends to facilitate the synthesis of spherical particles, as a solvent.

Next, as shown in FIG. 1A, the magnetic fine particles 4 obtained in such a manner are aggregated at a comparatively high concentration and dispersed in a polymer to form a core 4a, and an intermediate layer 4b is formed around the core 4a, and a polymer layer 6 is further formed around the intermediate layer 4b to manufacture the magnetic bead 2.

In the present embodiment, first, the core 4a is manufactured. The core 4a is manufactured by any method and is manufactured, for example, as follows. First, the magnetic fine particles 4 are uniformly dispersed in a hydrophobic organic solvent, added into an aqueous solution in which a surfactant is dissolved, and emulsified to prepare a magnetic fine particle emulsion. The core 4a is formed by adding a monomer and a polymerization initiator thereto and causing a polymerization reaction.

Next, the intermediate layer 4b is formed around the core 4a. The intermediate layer 4b is formed by any method and is formed, for example, as follows. The intermediate layer 4b is formed by uniformly dispersing the magnetic fine particles 4 in a monomer so as to have a predetermined concentration, adding the dispersion to the core 4a together with a surfactant and a polymerization initiator, and causing a polymerization reaction.

After that, the polymer layer 6 is formed around the intermediate layer 4b. The polymer layer 6 is formed by any method and is formed, for example, as follows. The polymer layer 6 is formed by adding a predetermined amount of a monomer together with a surfactant and a polymerization initiator to the particles formed from the core 4a and the intermediate layer 4b and causing a polymerization reaction.

When the polymer constituting the polymer layer 6 and the polymer for dispersing the magnetic fine particles 4 in the intermediate layer 4b are the same type of polymer, the polymer layer 6 and the intermediate layer 4b can be formed at the same time by the method as mentioned above. When all of the polymer for densely gathering the magnetic fine particles 4 in the core 4a, the polymer in the intermediate layer 4b, and the polymer in the polymer layer 6 are the same type of polymer, the core 4a, the intermediate layer 4b, and the polymer layer 6 can also be formed at the same time.

Next, a specific method of using the magnetic bead (polymer particle containing magnetic material) 2 according to the present embodiment is described.

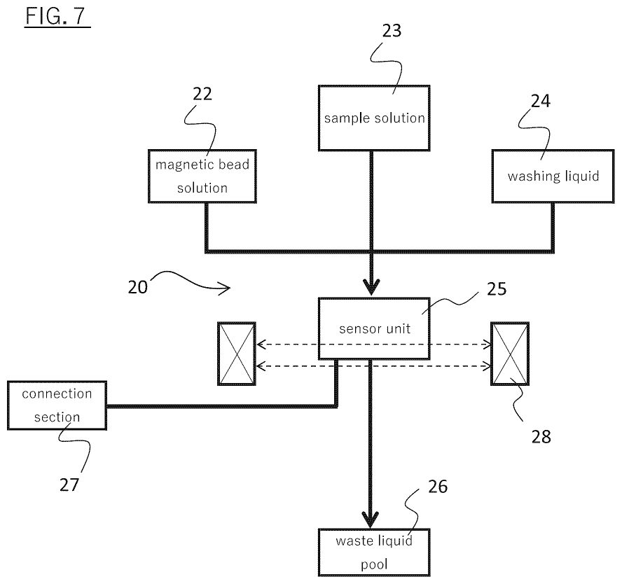

For example, a large number of magnetic beads 2 shown in FIG. 1A are dispersed in an aqueous solution, stored or transported as a magnetic bead solution, and stored in a magnetic bead storage 22 of a nucleic acid detection cartridge 20 shown in FIG. 7 used as, for example, a part of a sensor device. For example, a phosphate-buffered saline is used as the liquid for dispersing the magnetic beads 2. The cartridge 20 is used for sensing the existence or amount of a specific single-stranded nucleic acid 10a shown in FIG. 8B to FIG. 8E in a sample solution stored in a sample solution storage 23.

In the present embodiment, the cartridge 20 may include a washing liquid storage 24 and a waste liquid storage 26, in addition to the magnetic bead storage 22 and the sample solution storage 23. A washing liquid is stored in the washing liquid storage 24. The washing liquid, the sample solution, the bead solution, or the like that is no longer needed in a sensor unit 25 is discharged to the waste liquid storage 26. The washing liquid is, for example, a phosphate-buffered saline.

The cartridge 20 also includes the sensor unit 25, and the sensor unit 25 is connected to a connection section 27 for transmitting and receiving signals to and from an external circuit. The connection section 27 may be an electrical connection section or may be a connection section for optical or wireless communication. A magnetic field application unit 28 is attached to either the cartridge 20 or a device for attaching the cartridge 20. The magnetic field application unit 28 applies, for example, a magnetic field as shown by the arrows A in FIG. 8E to the magnetic beads 2 bound to the single-stranded nucleic acid 10a as a target substance. Note that, the application direction of the magnetic field shown in FIG. 8E is an example for description, and the application direction of the magnetic field is not limited to the arrows A.

As shown in FIG. 8A, for example, the sensor unit 25 shown in FIG. 7 includes at least one type of sensor element 32 inside a substrate 30 with a protection film 30a. Capture probes 34 are arranged on the surface of the substrate 30 (the surface of the protection film 30a) located above the sensor element 32. Preferably, for example, the capture probes 34 contain a nucleic acid having a sequence complementary to at least a part of a double-stranded nucleic acid or a single-stranded nucleic acid as a target substance, but there is no limitation as long as it is a substance capable of capturing a target substance.

The capture probes 34 may be composed of DNA, RNA, or a combination of them. From the point of preventing degradation by DNA degrading enzymes and RNA degrading enzymes, the capture probes 34 may contain an artificial nucleic acid.

Examples of methods for immobilizing the capture probes 34 onto the substrate 30 include a method using photolithography and solid-phase chemical reaction, a method of dropping a solution containing a capture probe onto the substrate for immobilization, and the like. In the method using photolithography and solid-phase chemical reaction, each of the capture probes 34 may be synthesized on the substrate 30.

In the method of dropping a solution containing the capture probes 34 onto the substrate for immobilization, preferably, a functional group for immobilization onto the substrate (hereinafter, sometimes abbreviated as “immobilization group”) is provided at the ends of the capture probes 34, and a functional group capable of reacting with the immobilization group and forming a bond (hereinafter, sometimes abbreviated as “reactive group”) is also formed on the substrate. Examples of the combinations between the immobilization group and reactive group include a combination between an immobilization group, such as amino group, formyl group, thiol group, and succimidyl ester group, and a reactive group, such as carboxy group, amino group, formyl group, epoxy group, and maleimide group, a combination using a gold-thiol bond, and the like.

Examples of other methods of dropping a solution containing the capture probes 34 onto the substrate 30 for immobilization include a method of discharging the capture probes 34 having a silanol group at the ends onto a substrate having a silica portion on the sensor element, arranging them, and covalently bonding them by a silane coupling reaction.

Preferably, the sensor element 32 is a magnetic sensor element. This is because the detection signal increases according to the number of magnetic beads 2, and the concentration of the single-stranded nucleic acid (or double-stranded nucleic acid) as a target substance can be quantified with a high accuracy. For example, the magnetic sensor element can be a magnetoresistive element. The magnetoresistive effect element is not limited as long as it is an element utilizing a phenomenon in which the electric resistance value changes under the influence of a magnetic field, but is preferably an element provided with a magnetization fixed layer having a magnetization direction fixed in a predetermined direction in the lamination plane and a magnetization free layer whose magnetization direction changes according to an external magnetic field.

In the magnetoresistive element, the magnetization fixed direction of the magnetization fixed layer is substantially parallel or substantially antiparallel to the magnetic field applied for excitation of the magnetic beads and is the film surface direction of the magnetoresistive element. Note that, “substantially parallel” may be approximately parallel and may be deviated within a range of 10° or less.

Note that, the magnetoresistive element may be a giant magnetoresistive element (GMR element), a tunnel magnetoresistive element (TMR element), or the like, and that the electrical resistance value of the magnetoresistive element may change according to an angle between a magnetization direction of the magnetization fixed layer and an average magnetization direction of the magnetization free layer. The shape of the magnetoresistive element is not limited, but preferably has a meandering structure.

The magnetization free layer is composed of, for example, a soft magnetic film of a NiFe alloy or the like. One surface of the magnetization fixed layer is in contact with an antiferromagnetic film, and the other surface of the magnetization fixed layer is in contact with the intermediate layer. The antiferromagnetic film is composed of, for example, an antiferromagnetic Mn alloy, such as IrMn and PtMn. The magnetization fixed layer may be composed of a ferromagnetic material, such as a CoFe alloy and a NiFe alloy, or may have a structure in which a Ru thin film layer is sandwiched between ferromagnetic materials, such as a CoFe alloy and a NiFe alloy.

The sensor element 32 in FIG. 8A to FIG. 8E is disposed inside the substrate 30, but may be disposed on the surface of the substrate depending on the type of sensor element 32. A single type of sensor element 32 is exemplified as the sensor element 32, but a plurality of types of sensor elements 32 may be arranged inside or on the surface of the substrate 30 depending on the purpose.

The sample solution storage 23 shown in FIG. 7 stores a sample solution containing, for example, a double-stranded nucleic acid or the single-stranded nucleic acid 10a shown in FIG. 8B as a target substance and the binding auxiliary substance 10b. When the sample solution enters the sensor unit 25 from the sample solution storage 23, as shown in FIG. 8B and FIG. 8C, the sample solution comes into contact with the sensor unit 25, and the single-stranded nucleic acid 10a is captured by the capture probes 34. Before or after that, the single-stranded nucleic acid 10a and the binding auxiliary substance 10b also bind with each other. The single-stranded nucleic acid 10a and the binding aid substance 10b may be bound in advance.

When a free single-stranded nucleic acid 10a exists in the subsequent measurement system, the measurement accuracy decreases. Thus, after the single-stranded nucleic acid 10a and the capture probes 34 are bound, the free single-stranded nucleic acid is removed from the sensor unit 25 by, for example, a washing step of flowing a washing solution from the washing liquid storage 24 to the sensor unit 25 shown in FIG. 7 and washing it away to the waste liquid storage 26.

Next, when the magnetic bead solution is supplied from the magnetic bead storage 22 shown in FIG. 7 to the sensor unit 25, as shown in FIG. 8D and FIG. 8E, the auxiliary binding substance 10c of the magnetic bead 2 binds to the auxiliary binding substance 10b bound to the single-stranded nucleic acid 10a captured by the capture probes 34 in the sensor unit 25.

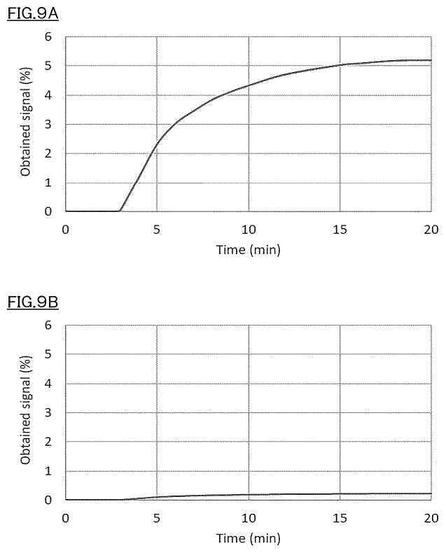

A magnetic field A is applied toward the captured magnetic bead 2 shown in FIG. 8E by the magnetic field application unit 28 concurrently with or before the supply of the magnetic bead solution from the magnetic bead storage 22 to the sensor unit 25 shown in FIG. 7. A change in the magnetic field from the magnetic bead 2 excited by the magnetic field A is detected as a change in resistance by the sensor element 32. FIG. 9A shows an example of the detection result.

In FIG. 9A, the horizontal axis represents an elapsed measurement time, and the vertical axis represents an output of the signal detected by the sensor element 32. The output of the sensor element 32 is continuously measured and, for example, these output saturation values can be used so as to obtain a concentration of the target single-stranded nucleic acid calculated from the output of the sensor element 32. The calculation of the concentration of the target single-stranded nucleic acid can be determined in advance by a nucleic acid detector (not illustrated) so that it can be automatically calculated from the measurement results. The process in which the magnetic beads 2 are adsorbed to the capture probes 34 on the sensor element 32 can be measured in real time with the nucleic acid detection cartridge 20 of the present embodiment.

According to the nucleic acid detection cartridge 20 of the present embodiment, it is possible to detect a target substance with high sensitivity, and there is an advantage that it is not necessary to use an unstable compound as in detection methods using conventional optical systems. The magnetic beads 2 of the present embodiment can be favorably used as a sensor medium for such a magnetic biosensor.

According to the magnetic beads 2 of the present embodiment, it is possible to achieve high sensor sensitivity and background signal (noise) reduction at the same time. This is probably because when each of the magnetic fine particles 4 in the magnetic beads 2 has a shape ratio within a predetermined range, sufficient magnetic characteristics for detection by the sensor element 32 are exhibited, and it is possible to prevent sedimentation of the polymer particles.

In the magnetic beads 2 of the present embodiment, since the polymer layer 6 is located around the core 4a, the dispersibility of the particles 4 is enhanced by reduction in aggregation among the particles 4, and sedimentation of the beads 2 can be prevented. Moreover, it is conceivable that high magnetization and low coercivity (superparamagnetism) can be achieved by the diameter Di of the inscribed circle C1 of the magnetic fine particles 4 within a predetermined range. Note that, if the diameter of the inscribed circle C1 of the magnetic fine particles 4 is too small, the surface area of the particles 4 increases, which tends to reduce the magnetization and the detection signal intensity. Moreover, if the above-mentioned relation formula is not satisfied, aggregation and sedimentation tend to easily occur due to ferromagnetism.

Moreover, when the shape ratio is within the above-mentioned range, the magnetization is improved by the crystallinity of the magnetite, and the packing property is improved by the shape effect of the magnetic fine particles 4. If the shape ratio is too high, the packing property is improved excessively, and the magnetic particles tend to be ferromagnetized. If the shape ratio is too low, the magnetic fine particles 4 are no longer isotropic, the packing property of the fine particles 4 decreases, the magnetization tends to decrease, and the magnetic fine particles 4 tend to be ferromagnetized due to the shape magnetic anisotropy of the fine particles.

When the intermediate layer 6 having a predetermined thickness is formed by controlling the distribution of the magnetic fine particles 4 in the magnetic beads 2, for example, the magnetic beads 2 can exhibit sufficient magnetic characteristics for detection by the sensor element 32 shown in FIG. 8E, and it is possible to prevent sedimentation of the magnetic beads 2. When the magnetic fine particles 4 contained in the core 4a and the intermediate layer 4b shown in FIG. 1A have an average particle size equal to or less than a predetermined value (e.g., 30 nm), a low coercivity (superparamagnetism) is obtained, and it is possible to prevent sedimentation due to mutual magnetic aggregation of the magnetic beads 2.

In the present embodiment, the thickness of the intermediate layer 4b shown in FIG. 1A and FIG. 5 is controlled at a predetermined ratio with respect to the particle radius of the magnetic beads 2. If the thickness of the intermediate layer 4 is too small, the thickness of the polymer layer 6 relatively becomes large, or the region of the core 4a relatively becomes large. If the thickness of the polymer layer 6 increases, the total amount of the magnetic fine particles 4 contained in the magnetic beads 2 tends to decrease, and the detection sensitivity tends to decrease. If the region of the core 4a relatively becomes large, the specific gravity of the magnetic beads 2 becomes large, and the magnetic beads 2 tend to settle easily. The specific gravity of the magnetic beads 2 depends on the type of liquid for dispersing the magnetic beads 2 and is preferably 1.1 to 2.6.

In the present embodiment, preferably, a ratio (x1/x2) of a diameter (x1) of the magnetic fine particles 4 to a diameter (x2) of the magnetic beads is 0.005 to 0.25. In such a range, it is easy to manufacture magnetic beads achieving high sensor sensitivity and background signal (noise) reduction at the same time.

In the present embodiment, the polymer constituting the polymer layer 6 contains an unpolymerized vinyl group. Moreover, as shown in FIG. 6, an intensity ratio of a peak in 1620 to 1640 cm⁻¹ to a peak in 1590 to 1610 cm⁻¹ in a FT-IR spectrum of the magnetic beads 2 is preferably 0.2 to 3.0. For example, when the polymer contains an unpolymerized vinyl group, the magnetic beads 2 are favorably dispersed in an aqueous solution (aqueous medium), aggregation and sedimentation are less likely to occur, and it is possible to prevent an increase in background signal. When an intensity ratio of a peak in 1620 to 1640 cm⁻¹ to a peak in 1590 to 1610 cm⁻¹ is 0.5 or more, the effect of improvement in dispersibility is enhanced. When an intensity ratio of a peak in 1620 to 1640 cm⁻¹ to a peak in 1590 to 1610 cm⁻¹ is 3.0 or less, the structure of the particles becomes firm, and it is possible to stably detect the target substance.

The present invention is not limited to the above-mentioned embodiment and may be changed variously within the scope of the present invention.

For example, the intermediate layer 4b is not necessarily required, and the polymer layer 6 may be present immediately around the core 4a. The sensor device using the magnetic bead 2 as the polymer particle containing magnetic material according to the present embodiment is not limited to the nucleic acid detection cartridge 20 shown in FIG. 7 and can be various sensor devices. Moreover, the target substance of the sensor device is not limited to a double-stranded nucleic acid or a single-stranded nucleic acid and may be other substances capable of binding to the polymer particle containing magnetic material.

### EXAMPLES

Hereinafter, the present invention is described based on more detailed examples, but is not limited to them.

### Example 1

### <Producing Magnetic Fine Particles and Magnetic Beads>

An iron (III) chloride hexahydrate was mixed with an ion-exchanged water and an ethanol and stirred for 30 minutes with a mechanical stirrer. After that, a solvent (octane) was poured in, a sodium oleate was added, and the mixture was further stirred for 30 minutes. The solution was heated to 70° C. with stirring and maintained at that temperature for 4 hours to synthesize an iron oleate. After cooling the solution, the solution was recovered, and an aqueous layer and an oil layer were separated with a separatory funnel so as to recover the oil layer.

A washing was performed by adding an ion-exchanged water to the oil layer and stirring it so as to remove the water layer. After this washing was repeated three times, the oil layer was recovered. A hexane solution of the obtained iron oleate was purified (removal of hexane) using an evaporator or the like so as to obtain an iron oleate (a waxy liquid with high viscosity).

The iron oleate as a raw material was stirred together with a dispersant (oleic acid) in a solvent (oleylamine) at 120° C. for 2 hours for dissolution. After that, the stirring speed was set to 500 rpm, the temperature of the solution was increased at a rate of 7° C./min, and the solution was subjected to a thermal decomposition for 2 hours at 350° C. (boiling point) while being refluxed. The solution after cooling was added with an ethanol for washing and stirred, and iron oxide nanoparticles (magnetic fine particles) were thereafter recovered by performing a centrifugation and removing the supernatant. This was repeated 5 times.

The obtained iron oxide nanoparticles were dispersed in octane to produce magnetic beads 2 as shown in FIG. 1A. Specifically, the magnetic beads 2 were produced as follows. That is, first, magnetic fine particles 4 were uniformly dispersed in n-octane so that the concentration would be 50 wt %, and a magnetic fine particle dispersion was prepared. An SDS aqueous solution obtained by dissolving sodium dodecyl sulfate (SD S) in an ion-exchanged water was prepared, added with the magnetic fine particle dispersion, and subjected to an emulsification treatment for 3 minutes at 50% output using an ultrasonic homogenizer (UP400S manufactured by Hielscher) to prepare a magnetic fine particle emulsion. After the magnetic fine particle emulsion was added with styrene and divinylbenzene (DVB) and stirred, potassium persulfate (KPS) was added as a polymerization initiator, and a polymerization reaction was performed at 80° C. for 18 hours in an argon gas atmosphere to produce a core 4a.

Next, after adding an appropriate amount of magnetic fine particles 4 into a mixture of styrene and DVB and dispersing them, they were mixed with the core 4a together with SDS and KPS and subjected to a polymerization reaction under the same conditions as described above to form an intermediate layer 4b around the core 4a. Moreover, the core 4a provided with the intermediate layer 4b was added with a mixed solution of styrene, DVB, and methacrylic acid together with SDS and KPS, mixed, and subjected to a polymerization reaction under the same conditions to form a polymer layer 6.

### <Measurement of Di and Ric>

10 or more of the obtained magnetic beads 2 were selected at random, and 20 or more magnetic fine particles 4 contained in each of the magnetic beads 2 were extracted at random. For each of the magnetic fine particles 4, a diameter Di (average) of an inscribed circle C1 and a shape ratio Ric (average) of the magnetic fine particle 4 were obtained by the above-mentioned method shown in FIG. 3A and FIG. 3B. Table 1 shows the results.

### <Measurement of Thickness of Intermediate Layer>

A HAADF-STEM image of the magnetic beads (polymer particles containing magnetic material) 2 was taken at a magnification of 200,000 times so that the number of particles whose entire outline was observed was 10 or more.

For the single magnetic bead 2, a relation between a distance (%) from an outer surface of the magnetic bead 2 to its center O and a detection intensity for brightness in a TEM (HAADF) image was determined by the method described with FIG. 1A in the embodiment. The results are shown by Ex. 1 in FIG. 5. From the graph of Ex. 1 in FIG. 5, the thickness of the intermediate layer 4b was determined by the above-mentioned method. Table 1 shows the results.

### <Magnetic Fine Particle Diameter X1>

100 or more magnetic fine particles 4 whose entire outline was observed were extracted at random from the above-mentioned HAADF-STEM image, and an arithmetic mean of their circle equivalent diameters was determined as a diameter (average) of the magnetic fine particles 4. Table 1 shows the results. The diameter (average) of the magnetic fine particles 4 was 11.8 nm. The maximum diameter of the magnetic fine particles 4 was 30 nm or less.

### <Diameter X2 of Magnetic Bead>

10 or more magnetic beads 2 whose entire outline was observed were extracted at random from the above-mentioned HAADF-STEM image, and an arithmetic mean of their circle equivalent diameters was determined as a particle diameter (average) of the magnetic beads 2. Table 1 shows the results. The diameter (average) of the magnetic beads 2 was 189 nm. The maximum diameter of the magnetic beads 2 was 1000 nm or less.

### <Saturation Magnetization of Magnetic Beads>

The saturation magnetization of the obtained magnetic beads 2 was measured as follows. First, about 10 mg of the magnetic beads 2 were filled in a resin container together with a paraffin, heated to melt the paraffin, and cooled to solidify it. Then, the magnetic beads 2 were fixed in the resin container. This was determined as a sample for magnetization measurement, and a magnetization was measured with a maximum applied magnetic field of 10 kOe using a vibrating sample magnetometer (VSM). Table 1 shows the results.

### <Modification of Binding Auxiliary Substance to Magnetic Beads>

As an example of the binding auxiliary substance 10c shown in FIG. 8D, streptavidin was added to the magnetic beads 2. In order to modify the surface of the magnetic beads 2 with streptavidin, first, the magnetic beads 2 were dispersed into a phosphate-buffered saline (PBS) adjusted to pH=6.0, and this dispersion was added with N-(3-Dimethylaminopropyl)-N-ethylcarbodiimide hydrochloride and N-hydroxysulfosuccinimide sodium salt and stirred for 30 minutes for reaction. After the reaction, a supernatant was removed, and this reactant was dispersed into a PBS adjusted to pH=7.4, added with streptavidin, and stirred for 3 hours for reaction to synthesize magnetic beads with streptavidin bound to the surface.

### <Producing Sensor Device>

A GMR element was used as a sensor element 32 shown in FIG. 8A used for the sensor unit 25 shown in FIG. 7. A substrate 30 having a carboxy group (—COOH) was used for the surface of a protection film 30a on the sensor element 32 consisting of the GMR element.

As capture probes 34 formed on the surface of the protection film 30a, a nucleic acid of 5′-AGCTCCTCCTCGGCTGCAAAGACAT-3′-NH2 (Sequence Number: 3) was used.

As the sample solution stored in a sample solution storage 23 shown in FIG. 7, a sample solution containing a single-stranded nucleic acid 10a and a binding auxiliary substance 10b shown in FIG. 8B was used. As the single-stranded nucleic acid, a single-stranded nucleic acid consisting of N1 shown below was used.

N1:
(Sequence Number: 1)
5′-ATGTCTTTGCAGCCGAGGAGGAGCTGGTGGAGGCTGACGAG
GCGGGCAGTGTGTATGCAGGCATCCTCAGCTACGGGGTGGGCTT
CTTCCTGTTCATCCTGGTGGT-3′

As the binding auxiliary substance 10b, a biotinylated probe (B1: Biotin-5′-ACCACCAGGATGAACAGGAAGAAGC-3′ (Sequence Number: 5)) shown below was used.

### <Magnetic Bead Solution>

A magnetic bead solution was prepared by mixing the above-mentioned streptavidin-attached magnetic beads 2 with 0.1 mass % of Tween 20 and a phosphate-buffered saline.

### <Measurement of Target Single-Stranded Nucleic Acid in Sample Solution>

The measurement of the target single-stranded nucleic acid in the sample solution was performed in the following procedure.

(1) A sample solution was prepared.

(2) A mixed solution obtained in (1) was heated at 97° C. for 20 minutes.

(3) After cooling the heated solution with ice, it was immediately injected into the sample solution storage 23 of the nucleic acid detection cartridge 20 shown in FIG. 7, set in a nucleic acid detector, and reached onto the sensor element 23 of the sensor unit 25.

(4) The solution was allowed to stand still for 30 minutes while being reached on the sensor element 23.

(5) Next, a washing liquid stored in the washing liquid storage 24 of the nucleic acid detection cartridge 20 was allowed to reach onto the sensor element 32 and wash the surface of the sensor element 32.

(6) An external magnetic field of 30 Oe was applied in the in-plane direction of the sensor element 32, and the measurement of the resistance value obtained by converting the output value of the sensor element 32 was started.

(7) While continuing to measure the resistance value of the sensor element 32, the magnetic bead solution stored in the magnetic bead solution storage 22 of the nucleic acid detection cartridge 20 was transmitted onto the sensor element 32.

(8) A resistance change rate (% output) of the sensor element 32 for 20 minutes after the magnetic bead solution was transferred was measured.

FIG. 9A illustrates an example of the measurement. Table 1 shows the measurement results of the resistance change rate r1₂₀ in 20 minutes. Table 1 also shows the measurement results of the resistance change rate r2₂₀ in 20 minutes after measuring the background signal (noise signal) using another sensor element (not illustrated). The value of r2₂₀/r1₂₀ in Table 1 represents a ratio of the magnitude of the noise signal to the required detection signal and is preferably lower. As shown in FIG. 8E, the value of the resistance change rate r1₂₀ corresponds to the number of magnetic beads 2 indirectly bound to the single-stranded nucleic acid 10a as a target substance captured by the capture probes 34 and is preferably larger. This is because detection accuracy is improved.

### Examples 2 and 3

The magnetic beads 2 were manufactured in the same manner as in Example 1, and the same measurements and evaluations as in Example 1 were performed, except for sequentially lengthening the thermal decomposition time and reducing the heating rate as the manufacturing conditions of the magnetic fine particles so that Ric sequentially became smaller than that in Example 1 as shown in Table 1. Table 1 shows the results.

### Example 4

The magnetic beads 2 were manufactured in the same manner as in Example 1, and the same measurements and evaluations as in Example 1 were performed, except for reducing the stirring speed and the thermal decomposition temperature and lengthening the thermal decomposition time so that Ric became further smaller than that in Example 3 as shown in Table 1. Table 1 shows the results.

### Comparative Example 1

The magnetic beads 2 were manufactured in the same manner as in Example 4, and the same measurements and evaluations as in Example 1 were performed, except for further reducing the stirring speed and further lengthening the thermal decomposition time as the manufacturing conditions of the magnetic fine particles so that Ric became further smaller than that in Example 4 as shown in Table 1. Table 1 shows the results. FIG. 9B shows an example of the measurement for resistance change rate r1₂₀, which changes with time.

### Example 5

The magnetic beads 2 were manufactured in the same manner as in Example 1, and the same measurements and evaluations as in Example 1 were performed, except for increasing the heating rate and decreasing the thermal decomposition temperature as the manufacturing conditions of the magnetic fine particles so that Di became smaller than that in Example 1 as shown in Table 1. Table 1 shows the results.

### Example 6

The magnetic beads 2 were manufactured in the same manner as in Example 2, and the same measurements and evaluations as in Example 1 were performed, except for decreasing the thermal decomposition temperature and shortening the thermal decomposition time as the manufacturing conditions of the magnetic fine particles so that Di became smaller than that in Example 2 as shown in Table 1. Table 1 shows the results.

### Example 7

The magnetic beads 2 were manufactured in the same manner as in Example 4, and the same measurements and evaluations as in Example 1 were performed, except for decreasing the thermal decomposition temperature and shortening the thermal decomposition time as the manufacturing conditions of the magnetic fine particles so that Di became smaller than that in Example 4 as shown in Table 1. Table 1 shows the results.

### Comparative Example 2

The magnetic beads 2 were manufactured in the same manner as in Example 7, and the same measurements and evaluations as in Example 1 were performed, except for decreasing the thermal decomposition temperature and shortening the thermal decomposition time as the manufacturing conditions of the magnetic fine particles so that Di became smaller than that in Comparative Example 1 as shown in Table 1. Table 1 shows the results.

### Comparative Example 3

The magnetic beads 2 were manufactured in the same manner as in Example 5, and the same measurements and evaluations as in Example 1 were performed, except for reducing the heating rate and decreasing the thermal decomposition temperature as the manufacturing conditions of the magnetic fine particles so that Di became further smaller than that in Example 5 as shown in Table 1. Table 1 shows the results.

### Comparative Example 4

The magnetic beads 2 were manufactured in the same manner as in Example 6, and the same measurements and evaluations as in Example 1 were performed, except for decreasing the thermal decomposition temperature and shortening the thermal decomposition time as the manufacturing conditions of the magnetic fine particles so that Di became further smaller than that in Example 6 as shown in Table 1. Table 1 shows the results.

### Comparative Example 5

The magnetic beads 2 were manufactured in the same manner as in Example 7, and the same measurements and evaluations as in Example 1 were performed, except for decreasing the thermal decomposition temperature and shortening the thermal decomposition time as the manufacturing conditions of the magnetic fine particles so that Di became smaller than that in Example 7 as shown in Table 1. Table 1 shows the results.

### Example 8

The magnetic beads 2 were manufactured in the same manner as in Example 1, and the same measurements and evaluations as in Example 1 were performed, except for increasing the heating rate and lengthening the thermal decomposition time as the manufacturing conditions of the magnetic fine particles so that Di became larger than that in Example 1 as shown in Table 1. Table 1 shows the results.

### Example 9

The magnetic beads 2 were manufactured in the same manner as in Example 2, and the same measurements and evaluations as in Example 1 were performed, except for reducing the heating rate and lengthening the thermal decomposition time as the manufacturing conditions of the magnetic fine particles so that Ric became smaller than that in Example 8 as shown in Table 1. Table 1 shows the results.

### Example 10

The magnetic beads 2 were manufactured in the same manner as in Example 9, and the same measurements and evaluations as in Example 1 were performed, except for reducing the stirring rate, reducing the heating rate, decreasing the thermal decomposition temperature, and lengthening the thermal decomposition time as the manufacturing conditions of the magnetic fine particles so that Di became further smaller than that in Example 9 as shown in Table 1. Table 1 shows the results.

### Example 11

The magnetic beads 2 were manufactured in the same manner as in Example 8, and the same measurements and evaluations as in Example 1 were performed, except for lengthening the thermal decomposition time as the manufacturing condition of the magnetic fine particles so that Di became further larger than that in Example 8 as shown in Table 1. Table 1 shows the results.

### Example 12

The magnetic beads 2 were manufactured in the same manner as in Example 11, and the same measurements and evaluations as in Example 1 were performed, except for reducing the heating rate and lengthening the thermal decomposition time as the manufacturing conditions of the magnetic fine particles so that Ric became smaller than that in Example 11 as shown in Table 1. Table 1 shows the results.

### Example 13

The magnetic beads 2 were manufactured in the same manner as in Example 12, and the same measurements and evaluations as in Example 1 were performed, except for reducing the heating rate as the manufacturing condition of the magnetic fine particles so that Ric became further smaller than that in Example 12 as shown in Table 1. Table 1 shows the results.

### Comparative Example 6

The magnetic beads 2 were manufactured in the same manner as in Example 13, and the same measurements and evaluations as in Example 1 were performed, except for reducing the stirring rate, decreasing the thermal decomposition temperature, and lengthening the thermal decomposition time as the manufacturing conditions of the magnetic fine particles so that Ric became further smaller than that in Example 13 as shown in Table 1. Table 1 shows the results.

### Example 14

The magnetic beads 2 were manufactured in the same manner as in Example 11, and the same measurements and evaluations as in Example 1 were performed, except for reducing the heating rate until the thermal decomposition temperature and lengthening the thermal decomposition time as the manufacturing conditions of the magnetic fine particles so that Di became further larger than that in Example 11 as shown in Table 1. Table 1 shows the results.

### Example 15

The magnetic beads 2 were manufactured in the same manner as in Example 14, and the same measurements and evaluations as in Example 1 were performed, except for using octadecene as a solvent and decreasing the thermal decomposition temperature as the manufacturing conditions of the magnetic fine particles so that Di became further larger than that in Example 14 as shown in Table 1. Table 1 shows the results.

### Comparative Example 7

The magnetic beads 2 were manufactured in the same manner as in Example 15, and the same measurements and evaluations as in Example 1 were performed, except for using oleylamine as a solvent and increasing the thermal decomposition temperature as the manufacturing conditions of the magnetic fine particles so that Di became further larger than that in Example 15 as shown in Table 1. Table 1 shows the results.

### Comparative Example 8

The magnetic beads 2 were manufactured in the same manner as in Comparative Example 1, and the same measurements and evaluations as in Example 1 were performed, except for increasing the thermal decomposition temperature and lengthening the thermal decomposition time as the manufacturing conditions of the magnetic fine particles so that Di became larger than that in Comparative Example 1 as shown in Table 1. Table 1 shows the results.

### Example 16

The magnetic beads 2 were manufactured in the same manner as in Example 12, and the same measurements and evaluations as in Example 1 were performed, except for lengthening the thermal decomposition time as the manufacturing condition of the magnetic fine particles so that Di became larger than that in Example 12 as shown in Table 1. Table 1 shows the results.

### Comparative Example 9

The magnetic beads 2 were manufactured in the same manner as in Example 16, and the same measurements and evaluations as in Example 1 were performed, except for reducing the heating rate and lengthening the thermal decomposition time as the manufacturing conditions of the magnetic fine particles so that Ric became smaller than that in Example 16 as shown in Table 1. Table 1 shows the results.

### Example 17

The magnetic beads 2 were manufactured in the same manner as in Example 8, and the same measurements and evaluations as in Example 1 were performed, except for increasing the heating rate for thermal decomposition reaction and shortening the thermal decomposition time as the manufacturing conditions of the magnetic fine particles so that Di became smaller than that in Example 16 as shown in Table 1. Table 1 shows the results.

### Example 18

The magnetic beads 2 were manufactured in the same manner as in Example 1, and the same measurements and evaluations as in Example 1 were performed, except for using octadecene as a solvent for manufacturing the magnetic fine particles and decreasing the thermal decomposition temperature so that Ric became larger than that in Example 1 as shown in Table 1. Table 1 shows the results.

### Comparative Example 10

The magnetic beads 2 were manufactured in the same manner as in Example 18, and the same measurements and evaluations as in Example 1 were performed, except for decreasing the thermal decomposition temperature so that Di became smaller than that in Example 18 as shown in Table 1. Table 1 shows the results.

### Comparative Examples 11 and 12

The magnetic beads 2 were manufactured in the same manner as in Comparative Example 12, and the same measurements and evaluations as in Example 1 were performed, except for lengthening the thermal decomposition time of the magnetic fine particles in each of Comparative Examples 11 and 12 so that Di became larger than that in Comparative Example 10 as shown in Table 1. Table 1 shows the results.

### <Evaluation 1>

As shown in Table 1 and FIG. 4, it was confirmed that the signal intensity r1₂₀ is large, and the signal intensity r2₂₀ (noise component) is small, in the magnetic beads of each Example in which the relation between the inscribed circle diameter Di and the shape ratio Ric of the magnetic fine particles is within a predetermined relation range (within a region surrounded by the straight lines L1 to L3 and the curve L4). That is, it was confirmed that the magnetic beads of Examples were favorably used as a part of a sensor medium for detecting, for example, double-stranded nucleic acids and single-stranded nucleic acids 10a. Note that, the signal intensity r1₂₀ is preferably 0.5 or more and is more preferably 1.5 or more, and that the noise ratio r2₂₀/r1₂₀ is preferably 0.5 or less and is more preferably 0.2 or less.

### Example 19 to 22

As shown in Table 2, the magnetic beads 2 were manufactured in the same manner as in Example 1, and the same measurements and evaluations as in Example 1 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 19 and 20 was smaller than that in Example 1 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 21 and 21 was larger than that in Example 1. Table 2 shows the results.

### Example 23 to 26

As shown in Table 2, the magnetic beads 2 were manufactured in the same manner as in Example 1, and the same measurements and evaluations as in Example 2 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 23 and 24 was smaller than that in Example 2 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 25 and 26 was larger than that in Example 2. Table 2 shows the results.

### Example 27 to 30

As shown in Table 2, the magnetic beads 2 were manufactured in the same manner as in Example 4, and the same measurements and evaluations as in Example 4 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 27 and 28 was smaller than that in Example 4 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 29 and 30 was larger than that in Example 4. Table 2 shows the results.

### Example 31 to 34

As shown in Table 2, the magnetic beads 2 were manufactured in the same manner as in Example 18, and the same measurements and evaluations as in Example 18 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 31 and 32 was smaller than that in Example 18 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 33 and 34 was larger than that in Example 18. Table 2 shows the results.

### Example 35 to 38

As shown in Table 2, the magnetic beads 2 were manufactured in the same manner as in Example 5, and the same measurements and evaluations as in Example 18 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 35 and 36 was smaller than that in Example 5 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 37 and 38 was larger than that in Example 5. Table 2 shows the results.

### Example 39 to 42

As shown in Table 2, the magnetic beads 2 were manufactured in the same manner as in Example 6, and the same measurements and evaluations as in Example 18 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 39 and 40 was smaller than that in Example 6 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 41 and 42 was larger than that in Example 6. Table 2 shows the results.

### Example 43 to 46

As shown in Table 2, the magnetic beads 2 were manufactured in the same manner as in Example 7, and the same measurements and evaluations as in Example 7 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 43 and 44 was smaller than that in Example 7 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 45 and 46 was larger than that in Example 7. Table 2 shows the results.

### Example 47 to 50

As shown in Table 2, the magnetic beads 2 were manufactured in the same manner as in Example 10, and the same measurements and evaluations as in Example 10 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 47 and 48 was smaller than that in Example 10 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 49 and 50 was larger than that in Example 10. Table 2 shows the results.

### Example 51 to 54

As shown in Table 2, the magnetic beads 2 were manufactured in the same manner as in Example 13, and the same measurements and evaluations as in Example 13 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 51 and 52 was smaller than that in Example 13 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 53 and 54 was larger than that in Example 13. Table 2 shows the results.

### Example 55 to 58

As shown in Table 2, the magnetic beads 2 were manufactured in the same manner as in Example 15, and the same measurements and evaluations as in Example 13 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 55 and 56 was smaller than that in Example 15 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 57 and 58 was larger than that in Example 15. Table 2 shows the results.

### Example 59 to 62

As shown in Table 2, the magnetic beads 2 were manufactured in the same manner as in Example 17, and the same measurements and evaluations as in Example 13 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) in each of Examples 59 and 60 was smaller than that in Example 17 and except for decreasing the number of magnetic fine particles 4 contained in the core 4a and increasing the amounts of magnetic fine particles, styrene, and DVB added at the time of producing the intermediate layer 4b so that the intermediate layer thickness (%) in each of Examples 61 and 62 was larger than that in Example 17. Table 2 shows the results.

### <Evaluation 2>

As shown in Table 2, it was confirmed that the signal intensity r1₂₀ is large, and the signal intensity r2₂₀ (noise component) is small, in the magnetic beads of each example in which the intermediate layer thickness of the magnetic fine particles is preferably within the range of 5.0 to 60%. It was also confirmed that the signal intensity r1₂₀ is larger, and the signal intensity r2₂₀ (noise component) is smaller, in the magnetic beads of each example in which the intermediate layer thickness of the magnetic fine particles is more preferably within the range of 10 to 42%.

### Example 63 to 67

As shown in Table 3, among the manufacturing conditions of the magnetic beads 2, the amount of the emulsifier was increased, and the ultrasonic irradiation time was lengthened, so that the average diameter of the magnetic beads 2 in each of Examples 63 to 65 was smaller than that in Example 5. On the other hand, the ultrasonic output was weakened, and the ultrasonic irradiation time was shortened, so that the average diameter of the magnetic beads 2 in each of Examples 66 and 67 was larger than that in Example 5. Otherwise, the magnetic beads 2 were manufactured in the same manner as in Example 5, and the same measurements and evaluations as in Example 5 were performed. Table 3 shows the results.

### Example 68

The magnetic beads 2 were manufactured in the same manner as in Example 5, and the same measurements and evaluations as in Example 5 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) was smaller than that in Example 5 as shown in Table 3. Table 3 shows the results.

### Example 69

The magnetic beads 2 were manufactured in the same manner as in Example 1, and the same measurements and evaluations as in Example 1 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) was smaller than that in Example 1 as shown in Table 3. Table 3 shows the results.

### Example 70

The magnetic beads 2 were manufactured in the same manner as in Example 15, and the same measurements and evaluations as in Example 15 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) was smaller than that in Example 15 as shown in Table 3. Table 3 shows the results.

### Example 71

The magnetic beads 2 were manufactured in the same manner as in Example 5, and the same measurements and evaluations as in Example 5 were performed, except for decreasing the number of magnetic fine particles 4 contained in the core 4a and increasing the amounts of magnetic fine particles, styrene, and DVB added at the time of producing the intermediate layer 4b so that the intermediate layer thickness (%) was larger than that in Example 5 as shown in Table 3. Table 3 shows the results.

### Example 72

The magnetic beads 2 were manufactured in the same manner as in Example 1, and the same measurements and evaluations as in Example 1 were performed, except for decreasing the number of magnetic fine particles 4 contained in the core 4a and increasing the amounts of magnetic fine particles, styrene, and DVB added at the time of producing the intermediate layer 4b so that the intermediate layer thickness (%) was larger than that in Example 1 as shown in Table 3. Table 3 shows the results.

### Example 73

The magnetic beads 2 were manufactured in the same manner as in Example 15, and the same measurements and evaluations as in Example 15 were performed, except for decreasing the number of magnetic fine particles 4 contained in the core 4a and increasing the amounts of magnetic fine particles, styrene, and DVB added at the time of producing the intermediate layer 4b so that the intermediate layer thickness (%) was larger than that in Example 15 as shown in Table 3. Table 3 shows the results.

### Examples 74 and 76

The magnetic beads 2 were manufactured, measured, and evaluated in the same manner as in Examples 70 and 68 except for increasing the amount of the emulsifier and lengthening the ultrasonic irradiation time among the manufacturing conditions of the magnetic beads 2 compared to Examples 70 and 68 so that the average diameter of the magnetic beads 2 in Examples 74 and 76 was small as shown in Table 3. Table 3 shows the results.

### Examples 75 and 77

The magnetic beads 2 were manufactured, measured, and evaluated in the same manner as in Examples 73 and 71 except for weakening the ultrasonic output and shortening the ultrasonic irradiation time among the manufacturing conditions of the magnetic beads 2 compared to Examples 73 and 71 so that the average diameter of the magnetic beads 2 in Examples 75 and 77 was large as shown in Table 3. Table 3 shows the results.

### Examples 78 to 82

As shown in Table 3, among the manufacturing conditions of the magnetic beads 2, the amount of the emulsifier was increased, and the ultrasonic irradiation time was lengthened, so that the average diameter of the magnetic beads 2 in each of Examples 78 to 80 was smaller than that in Example 6. On the other hand, the ultrasonic output was weakened, and the ultrasonic irradiation time was shortened, so that the average diameter of the magnetic beads 2 in each of Examples 81 and 82 was larger than that in Example 6. Otherwise, the magnetic beads 2 were manufactured in the same manner as in Example 6, and the same measurements and evaluations as in Example 6 were performed. Table 3 shows the results.

### Example 83

The magnetic beads 2 were manufactured in the same manner as in Example 6, and the same measurements and evaluations as in Example 6 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) was smaller than that in Example 6 as shown in Table 3. Table 3 shows the results.

### Example 84

The magnetic beads 2 were manufactured in the same manner as in Example 2, and the same measurements and evaluations as in Example 2 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) was smaller than that in Example 2 as shown in Table 3. Table 3 shows the results.

### Example 85

The magnetic beads 2 were manufactured in the same manner as in Example 13, and the same measurements and evaluations as in Example 13 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) was smaller than that in Example 13 as shown in Table 3. Table 3 shows the results.

### Example 86

The magnetic beads 2 were manufactured in the same manner as in Example 6, and the same measurements and evaluations as in Example 6 were performed, except for decreasing the number of magnetic fine particles 4 contained in the core 4a and increasing the amounts of magnetic fine particles, styrene, and DVB added at the time of producing the intermediate layer 4b so that the intermediate layer thickness (%) was larger than that in Example 6 as shown in Table 3. Table 3 shows the results.

### Example 87

The magnetic beads 2 were manufactured in the same manner as in Example 2, and the same measurements and evaluations as in Example 2 were performed, except for decreasing the number of magnetic fine particles 4 contained in the core 4a and increasing the amounts of magnetic fine particles, styrene, and DVB added at the time of producing the intermediate layer 4b so that the intermediate layer thickness (%) was larger than that in Example 2 as shown in Table 3. Table 3 shows the results.

### Example 88

The magnetic beads 2 were manufactured in the same manner as in Example 13, and the same measurements and evaluations as in Example 13 were performed, except for decreasing the number of magnetic fine particles 4 contained in the core 4a and increasing the amounts of magnetic fine particles, styrene, and DVB added at the time of producing the intermediate layer 4b so that the intermediate layer thickness (%) was larger than that in Example 13 as shown in Table 3. Table 3 shows the results.

### Examples 89 and 91

The magnetic beads 2 were manufactured, measured, and evaluated in the same manner as in Examples 85 and 83 except for increasing the amount of the emulsifier and lengthening the ultrasonic irradiation time among the manufacturing conditions of the magnetic beads 2 compared to Examples 85 and 83 so that the average diameter of the magnetic beads 2 in Examples 89 and 91 was small as shown in Table 3. Table 3 shows the results.

### Examples 90 and 92

The magnetic beads 2 were manufactured, measured, and evaluated in the same manner as in Examples 88 and 86 except for weakening the ultrasonic output and shortening the ultrasonic irradiation time among the manufacturing conditions of the magnetic beads 2 compared to Examples 88 and 86 so that the average diameter of the magnetic beads 2 in Examples 90 and 92 was large as shown in Table 3. Table 3 shows the results.

### Examples 91 to 95

As shown in Table 3, among the manufacturing conditions of the magnetic beads 2, the amount of the emulsifier was increased, and the ultrasonic irradiation time was lengthened, so that the average diameter of the magnetic beads 2 in each of Examples 91 to 93 was smaller than that in Example 7. On the other hand, the ultrasonic output was weakened, and the ultrasonic irradiation time was shortened, so that the average diameter of the magnetic beads 2 in each of Examples 94 and 95 was larger than that in Example 7. Otherwise, the magnetic beads 2 were manufactured in the same manner as in Example 7, and the same measurements and evaluations as in Example 7 were performed. Table 3 shows the results.

### Example 96

The magnetic beads 2 were manufactured in the same manner as in Example 7, and the same measurements and evaluations as in Example 7 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) was smaller than that in Example 7 as shown in Table 3. Table 3 shows the results.

### Example 97

The magnetic beads 2 were manufactured in the same manner as in Example 10, and the same measurements and evaluations as in Example 10 were performed, except for increasing the number of magnetic fine particles 4 contained in the core 4a and decreasing the amounts of magnetic fine particles, styrene, and DVB added at the time of producing the intermediate layer 4b so that the intermediate layer thickness (%) was smaller than that in Example 10 as shown in Table 3. Table 3 shows the results.

### Example 98

The magnetic beads 2 were manufactured in the same manner as in Example 7, and the same measurements and evaluations as in Example 7 were performed, except for decreasing the number of magnetic fine particles 4 contained in the core 4a and increasing the amounts of magnetic fine particles, styrene, and DVB added at the time of producing the intermediate layer 4b so that the intermediate layer thickness (%) was larger than that in Example 7 as shown in Table 3. Table 3 shows the results.

### Example 99

The magnetic beads 2 were manufactured in the same manner as in Example 10, and the same measurements and evaluations as in Example 10 were performed, except for decreasing the number of magnetic fine particles 4 contained in the core 4a and increasing the amounts of magnetic fine particles, styrene, and DVB added at the time of producing the intermediate layer 4b so that the intermediate layer thickness (%) was larger than that in Example 10 as shown in Table 3. Table 2 shows the results.

### Examples 100 and 102

The magnetic beads 2 were manufactured, measured, and evaluated in the same manner as in Examples 95 and 99 except for increasing the amount of the emulsifier and lengthening the ultrasonic irradiation time among the manufacturing conditions of the magnetic beads 2 compared to Examples 95 and 99 so that the average diameter of the magnetic beads 2 in Examples 97 and 102 was small as shown in Table 3. Table 3 shows the results.

### Examples 101 and 103

The magnetic beads 2 were manufactured, measured, and evaluated in the same manner as in Examples 96 and 98 except for weakening the ultrasonic output and shortening the ultrasonic irradiation time among the manufacturing conditions of the magnetic beads 2 compared to Examples 96 and 98 so that the average diameter of the magnetic beads 2 in Examples 101 and 103 was large as shown in Table 3. Table 3 shows the results.

### Example 104

The magnetic beads 2 were manufactured in the same manner as in Example 1, and the same measurements and evaluations as in Example 1 were performed, except for increasing the amount of the polymerization initiator among the manufacturing conditions of the magnetic beads 2 so that an intensity ratio of a peak in 1620 to 1640 cm⁻¹ to a peak in 1590 to 1610 cm⁻¹ in a FT-IR measurement was small as shown in

Table 4. Table 4 shows the results.

### Example 105

The magnetic beads 2 were manufactured in the same manner as in Example 104, and the same measurements and evaluations as in Example 1 were performed, except for increasing the amount of the polymerization initiator among the manufacturing conditions of the magnetic beads 2 so that an intensity ratio of a peak in 1620 to 1640 cm⁻¹ to a peak in 1590 to 1610 cm⁻¹ in a FT-IR measurement was further smaller than that in Example 104 as shown in Table 4. Table 4 shows the results. Moreover, the result of FT-IR spectrum analysis for the magnetic beads 2 according to Example 13 is indicated by Ex. 105 in FIG. 6.

### Example 106

The magnetic beads 2 were manufactured in the same manner as in Example 1, and the same measurements and evaluations as in Example 1 were performed, except for decreasing the amount of the polymerization initiator among the manufacturing conditions of the magnetic beads 2 so that an intensity ratio of a peak in 1620 to 1640 cm⁻¹ to a peak in 1590 to 1610 cm⁻¹ in a FT-IR measurement was larger than that in Example 1 as shown in Table 4. Table 4 shows the results.

### <Evaluation 5>

As shown in Table 4, it was confirmed that the noise ratio r2₂₀/r1₂₀ is small when the intensity ratio of the peak in 1620 to 1640 cm⁻¹ to the peak in 1590 to 1610 cm⁻¹ in the FT-IR spectrum analysis is 0.2 or more and 3.0 or less, and that the noise ratio r2₂₀/r1₂₀ is smaller when the intensity ratio of the peak in 1620 to 1640 cm⁻¹ to the peak in 1590 to 1610 cm⁻¹ in the FT-IR spectrum analysis is 0.5 or more and 3.0 or less.

In the FT-IR spectrum analysis, a sample was applied to a diamond analyzing crystal and subjected to a measurement with a resolution of 4 cm⁻¹ and 32 scans by attenuated total reflection method using a deuterium tri-glycine sulfate (DTGS) detector. In Example 1, as shown by Ex. 1 in FIG. 6, it was confirmed that the FT-IR spectrum has a peak in 1620 to 1640 cm⁻¹, and its peak intensity was 1.4 times the peak intensity in 1590 to 1610 cm⁻¹.

TABLE 1

| | Magnetic Fine Particles | | | | | | | | | |
|---|---|---|---|---|---|---|---|---|---|---|
| | Inscribed | | | Magnetic Beads | | | | | | |
| | Circle | Inscribed | Magnetic | | Magnetic | | | | | |
| | Diameter/ | Circle | Fine Particle | Intermediate | Bead | | | | | |
| | Circumcircle | Diameter | Diameter | Layer | Diameter | | Saturation | | | |
| | Diameter | Di | (X1) | Thickness | (X2) | | Magnetization | r1₂₀ | r2₂₀ | |
| | Ric | [nm] | [nm] | [%] | [nm] | X1/X2 | [emu/g] | [%] | [%] | r2₂₀/r1₂₀ |
| Ex. 1 | 0.89 | 11.6 | 12.3 | 16.8 | 191 | 0.06 | 45 | 5.19 | <0.01 | <0.01 |
| Ex. 2 | 0.72 | 10.6 | 12.5 | 16.0 | 180 | 0.07 | 43 | 4.70 | <0.01 | <0.01 |
| Ex. 3 | 0.60 | 13.7 | 17.7 | 17.0 | 216 | 0.08 | 42 | 3.60 | 0.08 | 0.02 |
| Ex. 4 | 0.50 | 11.2 | 15.8 | 20.1 | 200 | 0.08 | 20 | 1.20 | 0.22 | 0.18 |
| Comp. Ex. 1 | 0.47 | 11.0 | 16.0 | 21.5 | 185 | 0.09 | 13 | 0.20 | 0.05 | 0.25 |
| Ex. 5 | 0.93 | 5.3 | 5.5 | 17.2 | 212 | 0.03 | 24 | 2.12 | <0.01 | <0.01 |
| Ex. 6 | 0.72 | 5.1 | 6.0 | 15.7 | 210 | 0.03 | 22 | 1.64 | <0.01 | <0.01 |
| Ex. 7 | 0.51 | 5.4 | 7.6 | 21.6 | 212 | 0.04 | 20 | 1.50 | 0.15 | 0.10 |
| Comp. Ex. 2 | 0.46 | 5.1 | 7.5 | 19.1 | 211 | 0.04 | 10 | 0.10 | 0.01 | 0.10 |
| Comp. Ex. 3 | 0.90 | 3.2 | 3.4 | 21.3 | 183 | 0.02 | 16 | 0.28 | <0.01 | <0.01 |
| Comp. Ex. 4 | 0.71 | 3.3 | 3.9 | 20.0 | 192 | 0.02 | 16 | 0.26 | 0.01 | 0.04 |
| Comp. Ex. 5 | 0.52 | 3.5 | 4.9 | 21.9 | 215 | 0.02 | 14 | 0.25 | 0.01 | 0.04 |
| Ex. 8 | 0.92 | 16.0 | 16.7 | 20.9 | 204 | 0.08 | 48 | 5.41 | <0.01 | <0.01 |
| Ex. 9 | 0.77 | 15.2 | 17.3 | 20.5 | 195 | 0.09 | 44 | 4.50 | <0.01 | <0.01 |
| Ex. 10 | 0.51 | 16.8 | 23.5 | 18.6 | 188 | 0.13 | 21 | 1.30 | 0.15 | 0.12 |
| Ex. 11 | 0.93 | 23.0 | 23.8 | 20.7 | 202 | 0.12 | 52 | 4.87 | <0.01 | <0.01 |
| Ex. 12 | 0.80 | 22.1 | 24.7 | 17.9 | 197 | 0.13 | 51 | 4.89 | 0.55 | 0.11 |
| Ex. 13 | 0.69 | 20.8 | 25.0 | 17.7 | 178 | 0.14 | 41 | 4.40 | 0.58 | 0.13 |
| Comp. Ex. 6 | 0.61 | 22.3 | 28.6 | 15.3 | 217 | 0.13 | 42 | 4.43 | 3.20 | 0.72 |
| Ex. 14 | 0.88 | 25.5 | 27.2 | 15.9 | 186 | 0.15 | 56 | 5.31 | 0.78 | 0.15 |
| Ex. 15 | 0.94 | 27.8 | 28.7 | 15.2 | 209 | 0.14 | 55 | 5.20 | 0.86 | 0.17 |
| Comp. Ex. 7 | 0.92 | 31.0 | 32.3 | 21.0 | 210 | 0.15 | 55 | 5.83 | 4.00 | 0.69 |
| Comp. Ex. 8 | 0.45 | 19.0 | 28.3 | 18.8 | 185 | 0.15 | 15 | 0.20 | 0.08 | 0.40 |
| Comp. Ex. 9 | 0.75 | 25.0 | 28.9 | 20.2 | 207 | 0.14 | 41 | 3.89 | 8.40 | 2.16 |
| Ex. 16 | 0.82 | 24.2 | 26.7 | 17.1 | 201 | 0.13 | 32 | 3.60 | 0.41 | 0.11 |
| Ex. 17 | 0.89 | 19.0 | 20.1 | 25.2 | 205 | 0.10 | 52 | 4.92 | <0.01 | <0.01 |
| Ex. 18 | 0.94 | 12.2 | 12.6 | 19.7 | 193 | 0.07 | 51 | 5.10 | 0.80 | 0.16 |
| Comp. Ex. 10 | 0.95 | 5.3 | 5.4 | 20.7 | 197 | 0.03 | 28 | 3.11 | 1.66 | 0.53 |
| Comp. Ex. 11 | 0.97 | 17.3 | 17.6 | 15.8 | 189 | 0.09 | 49 | 5.20 | 3.80 | 0.73 |
| Comp. Ex. 12 | 0.96 | 29.8 | 30.4 | 16.6 | 179 | 0.17 | 51 | 5.52 | 3.60 | 0.65 |

TABLE 2

| | Magnetic Fine Particles | | | | | | | | | |
|---|---|---|---|---|---|---|---|---|---|---|
| | Inscribed | | | Magnetic Beads | | | | | | |
| | Circle | Inscribed | Magnetic | | Magnetic | | | | | |
| | Diameter/ | Circle | Fine Particle | Intermediate | Bead | | | | | |
| | Circumcircle | Diameter | Diameter | Layer | Diameter | | Saturation | | | |
| | Diameter | Di | (X1) | Thickness | (X2) | | Magnetization | r1₂₀ | r2₂₀ | |
| | Ric | [nm] | [nm] | [%] | [nm] | X1/X2 | [emu/g] | [%] | [%] | r2₂₀/r1₂₀ |
| Ex. 19 | 0.89 | 11.6 | 12.3 | 5.0 | 198 | 0.06 | 52 | 6.31 | 3.00 | 0.48 |
| Ex. 20 | 0.89 | 11.6 | 12.3 | 10.0 | 212 | 0.06 | 55 | 4.87 | 1.78 | 0.37 |
| Ex. 1 | 0.89 | 11.6 | 12.3 | 16.8 | 191 | 0.06 | 45 | 5.19 | <0.01 | <0.01 |
| Ex. 21 | 0.89 | 11.6 | 12.3 | 41.8 | 189 | 0.07 | 23 | 1.54 | <0.01 | <0.01 |
| Ex. 22 | 0.89 | 11.6 | 12.3 | 55.0 | 220 | 0.06 | 19 | 0.80 | <0.01 | <0.01 |
| Ex. 23 | 0.72 | 10.6 | 12.5 | 5.1 | 188 | 0.07 | 51 | 6.21 | 1.60 | 0.26 |
| Ex. 24 | 0.72 | 10.6 | 12.5 | 10.1 | 190 | 0.07 | 54 | 5.20 | 0.09 | 0.02 |
| Ex. 2 | 0.72 | 10.6 | 12.5 | 16.0 | 180 | 0.07 | 43 | 4.70 | <0.01 | <0.01 |
| Ex. 25 | 0.72 | 10.6 | 12.5 | 41.9 | 220 | 0.06 | 21 | 1.30 | <0.01 | <0.01 |
| Ex. 26 | 0.72 | 10.6 | 12.5 | 60.0 | 210 | 0.06 | 16 | 0.70 | <0.01 | <0.01 |
| Ex. 27 | 0.50 | 11.2 | 15.8 | 5.1 | 202 | 0.08 | 38 | 3.50 | 0.95 | 0.27 |
| Ex. 28 | 0.50 | 11.2 | 15.8 | 10.0 | 208 | 0.08 | 35 | 2.58 | 0.01 | 0.18 |
| Ex. 4 | 0.50 | 11.2 | 15.8 | 20.1 | 200 | 0.08 | 20 | 1.20 | 0.22 | 0.18 |
| Ex. 29 | 0.50 | 11.2 | 15.8 | 41.8 | 190 | 0.08 | 16 | 0.80 | <0.01 | <0.01 |
| Ex. 30 | 0.50 | 11.2 | 15.8 | 58.0 | 195 | 0.08 | 14 | 0.60 | <0.01 | <0.01 |
| Ex. 31 | 0.94 | 11.2 | 11.6 | 5.1 | 196 | 0.06 | 58 | 6.73 | 3.20 | 0.48 |
| Ex. 32 | 0.94 | 11.2 | 11.6 | 10.5 | 188 | 0.06 | 56 | 6.46 | 2.00 | 0.31 |
| Ex. 18 | 0.94 | 11.2 | 11.6 | 19.7 | 193 | 0.06 | 51 | 5.12 | 0.83 | 0.16 |
| Ex. 33 | 0.94 | 11.2 | 11.6 | 41.7 | 200 | 0.06 | 42 | 4.11 | 0.57 | 0.14 |
| Ex. 34 | 0.94 | 11.2 | 11.6 | 59.5 | 209 | 0.06 | 35 | 2.55 | <0.01 | <0.01 |
| Ex. 35 | 0.93 | 5.3 | 5.5 | 5.1 | 199 | 0.03 | 43 | 5.22 | 2.04 | 0.39 |
| Ex. 36 | 0.93 | 5.3 | 5.5 | 10.0 | 196 | 0.03 | 35 | 3.10 | 0.22 | 0.07 |
| Ex. 5 | 0.93 | 5.3 | 5.5 | 17.2 | 212 | 0.03 | 24 | 2.12 | <0.01 | <0.01 |
| Ex. 37 | 0.93 | 5.3 | 5.5 | 41.0 | 208 | 0.03 | 19 | 1.94 | <0.01 | <0.01 |
| Ex. 38 | 0.93 | 5.3 | 5.5 | 60.0 | 196 | 0.03 | 17 | 1.61 | <0.01 | <0.01 |
| Ex. 39 | 0.72 | 5.1 | 6.0 | 5.1 | 206 | 0.03 | 38 | 4.11 | 0.04 | 0.01 |
| Ex. 40 | 0.72 | 5.1 | 6.0 | 10.4 | 199 | 0.03 | 30 | 2.25 | 0.08 | 0.04 |
| Ex. 6 | 0.72 | 5.1 | 6.0 | 15.7 | 210 | 0.03 | 22 | 1.64 | <0.01 | <0.01 |
| Ex. 41 | 0.72 | 5.1 | 6.0 | 41.9 | 209 | 0.03 | 18 | 1.55 | 0.03 | 0.02 |
| Ex. 42 | 0.72 | 5.1 | 6.0 | 59.0 | 196 | 0.03 | 16 | 0.98 | <0.01 | <0.01 |
| Ex. 43 | 0.51 | 5.4 | 7.6 | 5.0 | 210 | 0.04 | 33 | 3.11 | 0.08 | 0.03 |
| Ex. 44 | 0.51 | 5.4 | 7.6 | 10.1 | 203 | 0.04 | 26 | 2.67 | 0.05 | 0.02 |
| Ex. 7 | 0.51 | 5.4 | 7.6 | 21.6 | 212 | 0.04 | 20 | 1.50 | 0.15 | 0.10 |
| Ex. 45 | 0.51 | 5.4 | 7.6 | 41.8 | 191 | 0.04 | 17 | 0.84 | <0.01 | <0.01 |
| Ex. 46 | 0.51 | 5.4 | 7.6 | 59.0 | 199 | 0.04 | 16 | 0.55 | <0.01 | <0.01 |
| Ex. 47 | 0.51 | 16.8 | 23.5 | 5.0 | 209 | 0.11 | 39 | 4.15 | 1.23 | 0.30 |
| Ex. 48 | 0.51 | 16.8 | 23.5 | 10.1 | 200 | 0.12 | 32 | 3.15 | 0.47 | 0.15 |
| Ex. 10 | 0.51 | 16.8 | 23.5 | 18.6 | 188 | 0.13 | 21 | 1.30 | 0.15 | 0.12 |
| Ex. 49 | 0.51 | 16.8 | 23.5 | 42.0 | 205 | 0.11 | 20 | 1.28 | 0.05 | 0.04 |
| Ex. 50 | 0.51 | 16.8 | 23.5 | 58.1 | 206 | 0.11 | 18 | 1.20 | <0.01 | <0.01 |
| Ex. 51 | 0.69 | 20.8 | 25.0 | 5.1 | 195 | 0.13 | 45 | 4.65 | 1.19 | 0.26 |
| Ex. 52 | 0.69 | 20.8 | 25.0 | 10.0 | 206 | 0.12 | 43 | 4.51 | 0.78 | 0.17 |
| Ex. 13 | 0.69 | 20.8 | 25.0 | 17.7 | 178 | 0.14 | 41 | 4.40 | 0.58 | 0.13 |
| Ex. 53 | 0.69 | 20.8 | 25.0 | 42.0 | 202 | 0.12 | 36 | 3.94 | 0.36 | 0.09 |
| Ex. 54 | 0.69 | 20.8 | 25.0 | 58.8 | 200 | 0.13 | 25 | 2.52 | 0.05 | 0.02 |
| Ex. 55 | 0.94 | 27.8 | 28.7 | 5.0 | 209 | 0.14 | 59 | 5.80 | 2.88 | 0.50 |
| Ex. 56 | 0.94 | 27.8 | 28.7 | 10.1 | 197 | 0.15 | 57 | 5.40 | 1.48 | 0.27 |
| Ex. 15 | 0.94 | 27.8 | 28.7 | 15.2 | 209 | 0.14 | 55 | 5.20 | 0.86 | 0.17 |
| Ex. 57 | 0.94 | 27.8 | 28.7 | 42.0 | 201 | 0.14 | 45 | 4.40 | 0.44 | 0.10 |
| Ex. 58 | 0.94 | 27.8 | 28.7 | 59.9 | 191 | 0.15 | 38 | 4.26 | 0.25 | 0.06 |
| Ex. 59 | 0.89 | 19.0 | 20.1 | 5.1 | 194 | 0.10 | 58 | 5.56 | 1.12 | 0.20 |
| Ex. 60 | 0.89 | 19.0 | 20.1 | 10.0 | 190 | 0.11 | 56 | 5.50 | 0.65 | 0.12 |
| Ex. 17 | 0.89 | 19.0 | 20.1 | 25.2 | 205 | 0.10 | 52 | 4.92 | <0.01 | <0.01 |
| Ex. 61 | 0.89 | 19.0 | 20.1 | 41.8 | 190 | 0.11 | 45 | 4.33 | 0.07 | 0.02 |
| Ex. 62 | 0.89 | 19.0 | 20.1 | 59.6 | 196 | 0.10 | 31 | 3.98 | <0.01 | <0.01 |

TABLE 3

| | Magnetic Fine Particles | | | | | | | | | |
|---|---|---|---|---|---|---|---|---|---|---|
| | Inscribed | | | | | | | | | |
| | Circle | Inscribed | Magnetic | Magnetic Beads | | | | | | |
| | Diameter/ | Circle | Fine Particle | Intermediate | Magnetic | | | | | |
| | Circumcircle | Diameter | Diameter | Layer | Bead | | Saturation | | | |
| | Diameter | Di | (X1) | Thickness | Diameter | | Magnetization | r1₂₀ | r2₂₀ | |
| | Ric | [nm] | [nm] | [%] | [nm] | X1/X2 | [emu/g] | [%] | [%] | r2₂₀/r1₂₀ |
| Ex. 63 | 0.93 | 5.3 | 5.5 | 17.2 | 22 | 0.25 | 22 | 1.89 | 0.03 | 0.02 |
| Ex. 64 | 0.93 | 5.3 | 5.5 | 17.1 | 51 | 0.11 | 23 | 2.05 | 0.04 | 0.02 |
| Ex. 65 | 0.93 | 5.3 | 5.5 | 16.8 | 103 | 0.053 | 23 | 2.12 | <0.01 | <0.01 |
| Ex. 5 | 0.93 | 5.3 | 5.5 | 17.2 | 212 | 0.026 | 24 | 2.12 | <0.01 | <0.01 |
| Ex. 66 | 0.93 | 5.3 | 5.5 | 17.2 | 515 | 0.011 | 26 | 2.33 | <0.01 | <0.01 |
| Ex. 67 | 0.93 | 5.3 | 5.5 | 16.5 | 1000 | 0.006 | 28 | 2.60 | 0.55 | 0.21 |
| Ex. 68 | 0.93 | 5.3 | 5.5 | 10.2 | 212 | 0.03 | 32 | 3.20 | 0.02 | 0.01 |
| Ex. 69 | 0.89 | 11.6 | 12.3 | 10.3 | 191 | 0.06 | 45 | 5.20 | 0.06 | 0.01 |
| Ex. 70 | 0.94 | 27.8 | 28.7 | 10.1 | 211 | 0.14 | 52 | 6.05 | 0.55 | 0.09 |
| Ex. 71 | 0.93 | 5.3 | 5.5 | 42.0 | 210 | 0.03 | 19 | 1.56 | 0.11 | 0.07 |
| Ex. 72 | 0.89 | 11.6 | 12.3 | 41.7 | 199 | 0.06 | 31 | 2.77 | 0.23 | 0.08 |
| Ex. 73 | 0.94 | 27.8 | 28.7 | 41.9 | 229 | 0.13 | 41 | 4.55 | 0.06 | 0.01 |
| Ex. 74 | 0.94 | 27.8 | 28.7 | 10.0 | 120 | 0.24 | 42 | 4.22 | 1.55 | 0.37 |
| Ex. 75 | 0.94 | 27.8 | 28.7 | 41.7 | 120 | 0.24 | 36 | 3.44 | 0.92 | 0.27 |
| Ex. 76 | 0.93 | 5.3 | 5.5 | 10.1 | 1000 | 0.006 | 58 | 6.23 | 1.50 | 0.24 |
| Ex. 77 | 0.93 | 5.3 | 5.5 | 41.9 | 1004 | 0.005 | 24 | 2.11 | 0.85 | 0.40 |
| Ex. 78 | 0.72 | 5.1 | 6.0 | 16.5 | 24 | 0.25 | 18 | 1.29 | 0.10 | 0.08 |
| Ex. 79 | 0.72 | 5.1 | 6.0 | 17.4 | 68 | 0.088 | 19 | 1.35 | 0.03 | 0.02 |
| Ex. 80 | 0.72 | 5.1 | 6.0 | 17.0 | 98 | 0.061 | 21 | 1.43 | <0.01 | <0.01 |
| Ex. 6 | 0.72 | 5.1 | 6.0 | 15.7 | 210 | 0.029 | 22 | 1.64 | <0.01 | <0.01 |
| Ex. 81 | 0.72 | 5.1 | 6.0 | 17.1 | 520 | 0.012 | 23 | 1.72 | <0.01 | <0.01 |
| Ex. 82 | 0.72 | 5.1 | 6.0 | 16.8 | 1010 | 0.006 | 25 | 1.88 | 0.35 | 0.19 |
| Ex. 83 | 0.72 | 5.1 | 6.0 | 10.0 | 200 | 0.030 | 25 | 1.89 | 0.05 | 0.03 |
| Ex. 84 | 0.72 | 10.6 | 12.5 | 10.2 | 180 | 0.069 | 46 | 4.80 | <0.01 | <0.01 |
| Ex. 85 | 0.69 | 20.8 | 25.0 | 10.0 | 178 | 0.140 | 47 | 4.98 | 0.09 | 0.02 |
| Ex. 86 | 0.72 | 5.1 | 6.0 | 41.8 | 199 | 0.030 | 22 | 1.60 | 0.04 | 0.03 |
| Ex. 87 | 0.72 | 10.6 | 12.5 | 41.8 | 180 | 0.069 | 37 | 3.21 | <0.01 | <0.01 |
| Ex. 88 | 0.69 | 20.8 | 25.0 | 42.0 | 178 | 0.140 | 39 | 3.55 | 0.04 | 0.01 |
| Ex. 89 | 0.69 | 20.8 | 25.0 | 10.1 | 105 | 0.24 | 45 | 4.75 | 0.58 | 0.12 |
| Ex. 90 | 0.69 | 20.8 | 25.0 | 42.0 | 100 | 0.25 | 38 | 3.33 | 0.58 | 0.17 |
| Ex. 91 | 0.72 | 5.1 | 6.0 | 10.1 | 1000 | 0.006 | 27 | 2.19 | <0.01 | <0.01 |
| Ex. 92 | 0.72 | 5.1 | 6.0 | 41.7 | 988 | 0.006 | 17 | 1.12 | <0.01 | <0.01 |
| Ex. 91 | 0.51 | 5.4 | 7.6 | 21.6 | 30 | 0.25 | 15 | 0.70 | 0.03 | 0.04 |
| Ex. 92 | 0.51 | 5.4 | 7.6 | 21.6 | 77 | 0.10 | 17 | 0.99 | <0.01 | <0.01 |
| Ex. 93 | 0.51 | 5.4 | 7.6 | 21.6 | 120 | 0.06 | 18 | 1.20 | <0.01 | <0.01 |
| Ex. 7 | 0.51 | 5.4 | 7.6 | 21.6 | 212 | 0.04 | 20 | 1.50 | <0.01 | <0.01 |
| Ex. 94 | 0.51 | 5.4 | 7.6 | 21.6 | 490 | 0.02 | 21 | 1.60 | 0.02 | 0.01 |
| Ex. 95 | 0.51 | 5.4 | 7.6 | 21.6 | 984 | 0.01 | 22 | 1.72 | 0.05 | 0.03 |
| Ex. 96 | 0.51 | 5.4 | 7.6 | 10.1 | 212 | 0.04 | 23 | 1.88 | 0.07 | 0.04 |
| Ex. 97 | 0.51 | 16.8 | 23.5 | 10.1 | 188 | 0.13 | 26 | 2.20 | 0.02 | 0.01 |
| Ex. 98 | 0.51 | 5.4 | 7.6 | 41.7 | 212 | 0.04 | 15 | 0.79 | <0.01 | <0.01 |
| Ex. 99 | 0.51 | 16.8 | 23.5 | 41.6 | 188 | 0.13 | 16 | 0.92 | <0.01 | <0.01 |
| Ex. 100 | 0.51 | 16.8 | 23.5 | 10.0 | 95 | 0.25 | 20 | 1.51 | <0.01 | <0.01 |
| Ex. 101 | 0.51 | 16.8 | 23.5 | 41.6 | 96 | 0.24 | 18 | 1.20 | <0.01 | <0.01 |
| Ex. 102 | 0.51 | 5.4 | 7.6 | 10.1 | 1001 | 0.008 | 24 | 2.00 | 0.20 | 0.10 |
| Ex. 103 | 0.51 | 5.4 | 7.6 | 41.7 | 999 | 0.008 | 19 | 1.30 | 0.04 | 0.03 |

TABLE 4

| | Magnetic Fine Particles | | | | | | | | | | |
|---|---|---|---|---|---|---|---|---|---|---|---|
| | Inscribed | | | | | | | | | | |
| | Circle | Inscribed | Magnetic | Magnetic Beads | | | | | | | |
| | Diameter/ | Circle | Fine Particle | Intermediate | Magnetic | | | | | | |
| | Circumcircle | Diameter | Diameter | Layer | Bead | | Saturation | FT-IR Peak | | | |
| | Diameter | Di | (X1) | Thickness | Diameter | | Magnetization | Intensity | r1₂₀ | r2₂₀ | |
| | Ric | [nm] | [nm] | [%] | [nm] | X1/X2 | [emu/g] | Ratio | [%] | [%] | r2₂₀/r1₂₀ |
| Ex. 1 | 0.89 | 11.6 | 12.3 | 16.8 | 191 | 0.06 | 45 | 1.6 | 5.19 | <0.01 | <0.01 |
| Ex. 104 | 0.89 | 11.6 | 12.3 | 16.8 | 199 | 0.06 | 44 | 0.5 | 4.80 | 2.10 | 0.44 |
| Ex. 105 | 0.89 | 11.6 | 12.3 | 16.8 | 196 | 0.06 | 43 | 0.2 | 5.10 | 0.80 | 0.16 |
| Ex. 106 | 0.89 | 11.6 | 12.3 | 16.8 | 189 | 0.06 | 44 | 3 | 5.03 | 0.08 | 0.02 |

### DESCRIPTION OF THE REFERENCE NUMERICAL

2 . . . magnetic bead (polymer particle containing magnetic material)
4 . . . magnetic fine particle
4a . . . core
4b . . . intermediate layer
6 . . . polymer layer
10a . . . single-stranded nucleic acid
10b, 10c . . . binding auxiliary substance
20 . . . nucleic acid detection cartridge (sensor device)
22 . . . magnetic bead storage
23 . . . sample solution storage
24 . . . washing liquid storage
25 . . . sensor unit
26 . . . waste liquid storage
27 . . . connection section
28 . . . magnetic field application unit
30 . . . substrate
32 . . . sensor element
34 . . . capture probe

What is claimed is:

1. A polymer particle containing magnetic material, comprising:
a core including magnetic fine particles; and
a polymer layer located outside the core and surrounding the core, wherein
a shape ratio (Ric) is defined in each of the magnetic fine particles by dividing a diameter (Di) of an inscribed circle of the magnetic fine particle by a diameter (Do) of a circumscribed circle of the magnetic fine particle,
the shape ratio (Ric) of the magnetic fine particle is 0.50 or more and 0.94 or less,
the diameter (Di) of the magnetic fine particle is 5 nm or more, and
the diameter (Di) and the shape ratio (Ric) of the magnetic fine particle satisfy a relation formula of Di≤9.28×e\hat{ }(1.17×Ric).

2. The polymer particle containing magnetic material according to claim 1, comprising an intermediate layer located inside the polymer layer and outside the core and having a lower concentration of the magnetic fine particles than the core,
wherein a thickness of the intermediate layer is 5% or more and 60% or less of a radius of the polymer particle containing magnetic material.

3. The polymer particle containing magnetic material according to claim 2, wherein a thickness of the intermediate layer is 10% or more and 42% or less of a radius of the polymer particle containing magnetic material.

4. The polymer particle containing magnetic material according to claim 1, wherein a ratio (x1/x2) of a diameter (x1) of the magnetic fine particles to a diameter (x2) of the polymer particle containing magnetic material is 0.005 or more and 0.25 or less.

5. The polymer particle containing magnetic material according to claim 1, wherein a polymer constituting the polymer layer contains an unpolymerized vinyl group.

6. The polymer particle containing magnetic material according to claim 1, further comprising a portion capable of directly or indirectly combining with a target substance.

7. A medium for sensors comprising the polymer particle containing magnetic material according to claim 1.

8. A sensor device comprising a sensor unit for detecting a magnetism of the polymer particle containing magnetic material according to claim 1 combining with a target substance.
